(19) United States
(12) Patent Application Publication
(10) Pub. No.: US 2014/0337403 A1
(43) Pub. Date: Nov. 13, 2014

(54) COMPUTING DEVICE, COMPUTING METHOD, AND COMPUTER PROGRAM PRODUCT

(71) Applicant: KABUSHIKI KAISHA TOSHIBA, Tokyo (JP)

(72) Inventors: Tomoko Yonemura, Kawasaki-shi (JP); Hirofumi Muratani, Kawasaki-shi (JP)

(73) Assignee: KABUSHIKI KAISHA TOSHIBA, Tokyo (JP)

(21) Appl. No.: 14/203,021

(22) Filed: Mar. 10, 2014

(30) Foreign Application Priority Data
May 9, 2013 (JP) 2013-099409

(51) Int. Cl. G06F 17/10

(52) U.S. Cl. CPC G06F 17/10
USPC 708/606

(57) ABSTRACT

According to an embodiment, a computing device includes an input unit and a power computing unit. The input unit is configured to input, in a form of vector representation, an element of an algebraic torus selected from elements of an M-th (M is an integer of 2 or greater) degree extension field obtained by extending a finite filed by an M-th order polynomial. The power computing unit is configured to compute an N-th (N is an integer of 2 or greater) power of the input element of the algebraic torus, computing the N-th power being performed on the basis of an arithmetic expression for computing the N-th power of an element of the M-th degree extension field expressed in the form of vector representation, and the arithmetic expression being satisfied when the element of the M-th degree extension field satisfies a condition for an element of the algebraic torus.

### CROSS-REFERENCE TO RELATED APPLICATIONS

This application is based upon and claims the benefit of priority from Japanese Patent Application No. 2013-099409, filed on May 9, 2013; the entire contents of which are incorporated herein by reference.

### FIELD

Embodiments described herein relate generally to a computing device that computes a power of an element of a finite field, a computing method therefor, and a computer program product.

### BACKGROUND

There have been proposed methods for compressing the size of public keys, the size of ciphertexts and the like by using a set called an algebraic torus among sets of numbers used for public key cryptography. In addition, cryptographic protocols using pairing have been proposed.

In encryption and pairing-based cryptography using algebraic tori, a power of an element of an algebraic torus is computed. It is thus desired to reduce the computational cost of power computation of an element of an algebraic torus.

### BRIEF DESCRIPTION OF THE DRAWINGS

FIG. 1 is a configuration diagram of a computing device according to a first embodiment;

FIG. 2 is a configuration diagram of a computing device according to a second embodiment;

FIG. 3 is a configuration diagram of a computing device according to a third embodiment; and

FIG. 4 is a hardware configuration diagram of a computing device.

### DETAILED DESCRIPTION

According to an embodiment, a computing device includes an input unit and a power computing unit. The input unit is configured to input, in a form of vector representation, an element of an algebraic torus selected from elements of an M-th (M is an integer of 2 or greater) degree extension field obtained by extending a finite filed by an M-th order polynomial. The power computing unit is configured to compute an N-th (N is an integer of 2 or greater) power of the input element of the algebraic torus, computing the N-th power being performed on the basis of an arithmetic expression for computing the N-th power of an element of the M-th degree extension field expressed in the form of vector representation, and the arithmetic expression being satisfied when the element of the M-th degree extension field satisfies a condition for an element of the algebraic torus.

A computing device according to an embodiment will be described below. A computing device according to an embodiment is used for processing of algebraic torus based cryptography and pairing based cryptography, for example.

### First Embodiment

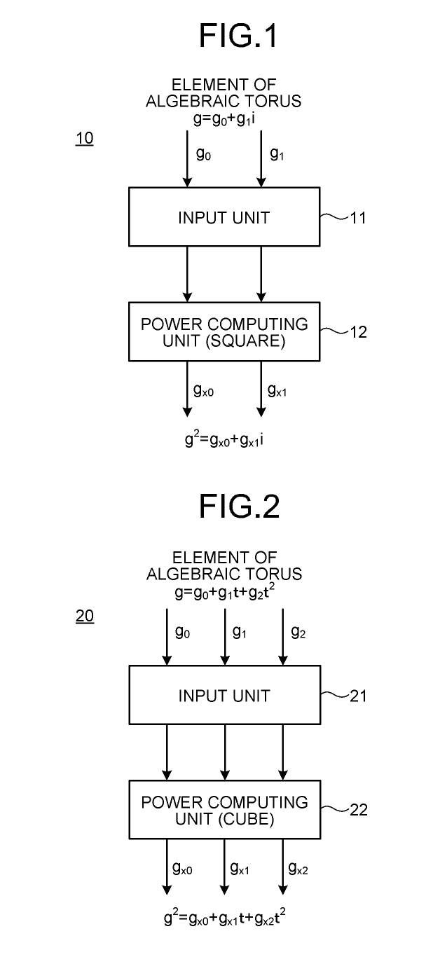

FIG. 1 illustrates the configuration of a computing device 10 according to the first embodiment. The computing device 10 calculates and outputs the square of an element of an algebraic torus.

The computing device 10 includes an input unit 11 and a power computing unit 12. The input unit 11 inputs an element of an algebraic torus selected from elements of a quadratic extension field obtained by extending a finite field by a quadratic polynomial.

Note that an element of an algebraic torus is an element that is not included in a subfield among elements of an extension field that is an extension of a base field. Multiplication of an element of an algebraic torus is performed by the same operation as multiplication of a finite field.

The input unit 11 inputs an element of the algebraic torus in the form of vector representation. Specifically, an element g of the quadratic extension field can be expressed by a linear expression of a variable i such as g=g₀+g₁×i. The input unit 11 inputs the coefficient g₀ of the zero order term and the coefficient g₁ of the first order term in such an expression. Thus, the input unit 11 inputs an element of the algebraic torus in the form of a coefficient of a polynomial, for example.

The power computing unit 12 computes the square of the input element of the algebraic torus by a preset arithmetic expression. The power computing unit 12 then outputs the result of square computation in the form of vector representation. In this example, the power computing unit 12 outputs the coefficient gₓ₀ of the zero order term and the coefficient gₓ₁ of the first order term when the square computation result g² is expressed by a linear expression of a variable i.

Note that the power computing unit 12 computes the square of the input element of the algebraic torus, computing the square being performed on the basis of an arithmetic expression for squaring an element of a quadratic extension field expressed in the form of vector representation, and the arithmetic expression being satisfied when the element of the quadratic extension field satisfies the condition for an element of the algebraic torus.

Specifically, when i represents a variable, b represents an element included in a finite field, and a quadratic polynomial for extending the finite field is represented by i²−b, the power computing unit 12 executes the arithmetic expression of the following Expression (1) to calculate the square g² of the input element of the algebraic torus.

g²=(2g₀²−1)+2g₀g₁i (1)

The computing device 10 can compute the square at a smaller cost by using such an arithmetic expression than using a common arithmetic expression.

The arithmetic expression of Expression (1), that is, the arithmetic expression for squaring an element of the quadratic extension field can be derived by adding a zero order term, which is derived by substituting an expression representing an element of the quadratic extension field and an expression representing a Frobenius conjugate element into the expression representing the condition for an element of the algebraic torus, to the arithmetic expression of the square of an element of the quadratic extension field in the form of vector representation. The reason for which the power computing unit 12 can compute the square of an element of the algebraic torus by using such an arithmetic expression of Expression (1) will be described in detail below.

A polynomial for quadratic extension of a base field F_{q} is expressed by Expression (11). Here, i represents a variable and b represents an element selected from the base field F_{q}. In addition, q represents the order of the base field F_{q}.

i²−b (11)

In this case, the quadratic extension field F_{q̂2} of the base field F_{q} is expressed by Expression (12). Note that “X̂Y” represents the Y-th power of X.

F_{q̂2}=F_{q}[i]/(i²−b) (12)

Furthermore, an element g of the quadratic extension field F_{q̂2} is expressed by Expression (13). A Frobenius conjugate element g^{q} of the quadratic extension field F_{q̂2} is expressed by Expression (14).

g=g₀+g₁i (13)

g^{q}=g₀−g₁i (14)

Note that an element of the algebraic torus is an element that is not included in a subfield in the quadratic extension field F_{q̂2}. Thus, the element of the algebraic torus in the quadratic extension field F_{q̂2} obtained by the extension by Expression (11) satisfies Expression (15) and Expression (16). In other words, Expression (15) and Expression (16) are expressions representing the conditions for the element of the algebraic torus.

g^{q-1}≠1 (15)

g^{q+1}=1 (16)

Expression (16) is converted to Expression (17).

g·g^{q}=1 (17)

Expression (13) representing the element g of the quadratic extension field F_{q̂2} and Expression (14) representing the Frobenius conjugate element gq are substituted into Expression (17). As a result, Expression (17) is converted to Expression (18).

(g₀+g₁i)(g₀−g₁i)=1 (18)

Expression (18) is developed into Expression (19).

g₀²−g₁²i²=1 (19)

Since i²=b is obtained from the solution of the polynomial of Expression (11), Expression (19) is converted to Expression (20).

g₀²−g₁²b=1 (20)

Transposition of the value on the right-hand side of Expression (20) to the left-hand side results in Expression (21).

g₀²−g₁²b−1=0 (21)

In this manner, as a result of substituting the expressions representing the element g of the quadratic extension field F_{q̂2} and the Frobenius conjugate element g^{q} into the expression representing the condition for the element of the algebraic torus, the expression of the zero order term of the variable i as Expression (21) can be derived.

The arithmetic expression of the square of the element g of the quadratic extension field F_{q̂2} expressed in the form of vector representation is expressed as in Expression (22).

$$\begin{matrix}{g}^{2} = g \cdot g \\ = ( {g}_{0} + {g}_{1} i ) ( {g}_{0} + {g}_{1} i ) \\ = {g}_{0}^{2} + 2 {g}_{0} {g}_{1} i + {g}_{1}^{2} {i}^{2}\end{matrix} \qquad ( 22 )$$

Since i²=b is obtained from the solution of the polynomial of Expression (11), Expression (22) is converted to Expression (23).

g²=g₀²+g₁²b+2g₀gᵢi (23)

Addition of the expression on the left-hand side of Expression (21) to the zero order term of Expression (23) results in Expression (24).

g²=g₀²+g₁²b+2g₀gᵢi+(g₀²−g₁²b−1) (24)

Expression (24) is rearranged into Expression (25).

g²=2g₀²−1+2g₀gᵢi (25)

The expression of Expression (25) is identical to Expression (1). It can therefore be said that the square of an element of the algebraic torus of the quadratic extension field obtained by extension by i²−b can be computed by Expression (1).

Assume that the cost for computing the square of an element in a base field is S, the cost for multiplication of an element in the base field is M, the cost for multiplication of an element in the base field and a constant is m, and the cost for addition is 0. In this case, the computational cost of Expression (23) that is a common arithmetic expression for a square is M+2S+m. In contrast, the computational cost of Expression (1) is M+S.

As described above, according to the computing device 10 according to the first embodiment, the square computation can be performed at a smaller cost by using Expression (1) than using a common arithmetic expression.

### Second Embodiment

FIG. 2 illustrates the configuration of a computing device 20 according to the second embodiment. The computing device 20 calculates and outputs the cube of an element of an algebraic torus.

The computing device 20 includes an input unit 21 and a power computing unit 22. The input unit 21 inputs an element of an algebraic torus selected from elements of a cubic extension field obtained by extending a finite field by a cubic polynomial.

The input unit 21 inputs an element of the algebraic torus in the form of vector representation. Specifically, an element g of the cubic extension field can be expressed by a quadratic expression of a variable t such as g=g₀+g₁×t+g₂×t². The input unit 21 inputs the coefficient g₀ of the zero order term, the coefficient g₁ of the first order term, and the coefficient g₂ of the second order term in such an expression. Thus, the input unit 21 inputs an element of the algebraic torus in the form of a coefficient of a polynomial, for example.

The power computing unit 22 computes the cube of the input element of the algebraic torus by a preset arithmetic expression. The power computing unit 22 then outputs the result of cube computation in the form of vector representation. In this example, the power computing unit 22 outputs the coefficient gₓ₀ of the zero order term, the coefficient gₓ₁ of the first order term, and the coefficient gₓ₂ of the second order term when the cube computation result g³ is expressed by a quadratic expression of a variable t.

Note that the power computing unit 22 computes the cube of the input element of the algebraic torus, computing the cube being performed on the basis of an arithmetic expression for cubing an element of a cubic extension field expressed in the form of vector representation, and the arithmetic expression being satisfied when the element of the cubic extension field satisfies the condition for an element of an algebraic torus.

Specifically, when t represents a variable, s represents an element included in a finite field, and a cubic polynomial for extending the finite field is represented by t³−s, the power computing unit 22 executes the arithmetic expression of the following Expression (2) to calculate the cube g³ of the input element of the algebraic torus.

$${g}^{3} = ( 1 + 9 {sg}_{0} {g}_{1} {g}_{2} ) + 3 ( {g}_{0}^{2} {g}_{1} + {sg}_{2} {h}_{2} ) t + 3 ( {g}_{2} {g}_{0}^{2} + {g}_{1} {h}_{1} ) {t}^{2} \qquad ( 2 )$$

where

h₁=sg₂²+g₀g₁

h₂=g₁²+g₀g₂

The computing device 20 can compute the cube at a smaller cost by using such an arithmetic expression than using a common arithmetic expression.

The arithmetic expression of Expression (2), that is, the arithmetic expression for cubing an element of the cubic extension field can be derived by adding a zero order term, which is derived by substituting an expression representing an element of the cubic extension field and an expression representing a Frobenius conjugate element into the expression representing the condition for an element of the algebraic torus, to the arithmetic expression of the cube of an element of the cubic extension field in the form of vector representation. The reason for which the power computing unit 22 can compute the cube of an element of the algebraic torus by using such an arithmetic expression as Expression (2) will be described in detail below.

A polynomial for cubic extension of a base field F_{q} is expressed by Expression (31). Here, t represents a variable and s represents an element selected from the base field F_{q}.

t³−s (31)

In this case, the cubic extension field F_{q̂3} of the base field F_{q} is expressed by Expression (32).

F_{q̂3}=F_{g}[t]/(t³−s) (32)

Furthermore, an element g of the cubic extension field F_{q̂3} is expressed by Expression (33). Frobenius conjugate elements g^{q} and g^{q̂2} of the cubic extension field F_{q̂3} are expressed by Expression (34) and Expression (35).

g=g₀+g₁t+g₂t² (33)

g^{q}=g₀+g₁s₁t+g₂s₂t² (34)

g^{q̂2}=g₀+g₁s₂t+g₂s₁t² (35)

Note that s₁ is as expressed by Expression (36). Also note that s₂ is as expressed by Expression (37).

s₁=s^{1/3(q-1)} (36)

s₂=s^{2/3(q-1)} (37)

Note that an element of the algebraic torus is an element that is not included in a subfield in the cubic extension field F_{q̂3}. Thus, the element of the algebraic torus in the cubic extension field F_{q̂3} obtained by the extension by Expression (31) satisfies Expression (38) and Expression (39). In other words, Expression (38) and Expression (39) are expressions representing the conditions for the element of the algebraic torus.

g^{q-1}≠1 (38)

g^{q̂3-1}=1 (39)

Factorization of (q³−1) results in Expression (40).

q³−1=(q−1)(q²+q+1) (40)

Under the condition of Expression (38), (q−1) is not 0. Thus, the condition of Expression (39) can be converted to Expression (41).

g^{q̂2+q+1}=1 (41)

Expression (41) is converted to Expression (42).

g^{q̂2}·g^{q}·q=1 (42)

Expression (33) representing the element g of the cubic extension field F_{q̂3} and Expression (34) and Expression (35) representing Frobenius conjugate elements g^{q} and g^{q̂2} are substituted into Expression (42). As a result, Expression (42) is converted to Expression (43).

(g₀+g₁s₂t+g₂s₁t²)(g₀+g₁sᵢt+g₂s2t²)(g₀+g₁t+g₂t²)=1 (43)

Development of the left two terms in parentheses of the left-hand side of Equation (43) results in Expression (44).

[g₀²+g₀g₁(s₁+s₂)t+{(g₀g₁(s₁+s₂)+g₁²s₁s₂)}t²+g₁g₂(s₁²+s₂²)t³+g₂²s₁s₂t⁴](g₀+g₁t+g₂t²)=1 (44)

Note that s₁·s₂ becomes 1 due to the property of a finite field as expressed by Expression (45).

$$\begin{matrix}{s}_{1} \cdot {s}_{2} = {s}^{\frac{q - 1}{3}} \cdot {s}^{\frac{2 ( q - 1 )}{3}} \\ = {s}^{q - 1} \\ = 1\end{matrix} \qquad ( 45 )$$

Furthermore, since s is an element selected from the base field F_{q}, s^{q-1}=1 is obtained. If s^{(q-1)/3}−1≠1, then s₁+s₂ is −1 as expressed by Expression (46).

$${s}^{\frac{2 ( q - 1 )}{3}} + {s}^{\frac{q - 1}{3}} + 1 = 0 \\ {s}_{2} + {s}_{1} + 1 = 0 \\ {s}_{1} + {s}_{2} = - 1 \qquad ( 46 )$$

Expression (44) into which Expression (45) and Expression (46) are substituted is converted to Expression (47).

{g₀²−g₀g₁t−(g₀g₂−g₁²)t²−g₁g₂t³+g₂²t⁴}·(g₀+g₁t+g₂t²)=1 (47)

Since t³=s can be obtained from the solution of the polynomial of Expression (31), Expression (47) is converted to Expression (48).

g₃³+sg₁³+s²g₂³−3sg₀g₁g₂=1 (48)

Transposition of the value on the right-hand side of Expression (48) to the left-hand side results in Expression (49).

g₃³+sg₁³+s²g³−3sg₀g₁g₂−1=0 (49)

In this manner, as a result of substituting the expressions representing the element g of the cubic extension field F_{q̂3} and the Frobenius conjugate elements g^{q} and g^{q̂2} into the expression representing the condition for the element of the algebraic torus, the expression of the zero order term of the variable t as Expression (49) can be derived.

The arithmetic expression of the cube g³ of the element g of the cubic extension field F_{q̂3} expressed in the form of vector representation is expressed as in Expression (50).

$${g}^{3} = ( {g}_{0}^{3} + {sg}_{1}^{3} + {s}^{2} {g}_{2}^{3} + 6 {sg}_{0} {g}_{1} {g}_{2} ) + 3 ( {g}_{0}^{2} {g}_{1} + s ( {g}_{1}^{2} {g}_{2} + {g}_{2}^{2} {g}_{0} ) ) t + 3 ( {g}_{2} {g}_{0}^{2} + {g}_{0} {g}_{1}^{2} + {sg}_{1} {g}_{2}^{2} ) {t}^{2} \qquad ( 50 )$$

Subtraction of the expression on the left-hand side of Expression (49) from the zero order term of Expression (50) results in Expression (51).

g³=(1+9sg₀g₁g₂)+3(g₀²g₁+sg₂h₂)t+3(g₂g₀²+g₁h₁)t² (51)

Here, h₁ and h₂ are as expressed by Expression (52) and Expression (53).

h₁=sg₂²+g₀g₁ (52)

h₂=g₁²+g₀g₂ (53)

The expression of Expression (51) is identical to Expression (2). It can therefore be said that the cube of an element of the algebraic torus of the cubic extension field obtained by extension by i³−s can be computed by Expression (2).

Assume that the cost for computing the cube of an element in a base field is S, the cost for multiplication of an element in the base field is M, the cost for multiplication of an element in the base field and a constant is m, and the cost for addition is 0. In this case, the computational cost of Expression (50) that is a common arithmetic expression for a cube is 6M+6S+4m. In contrast, the computational cost of Expression (2) is 7M+2S+3m. Typically, S/M is approximately 0.8. When S=0.8M, 6M+6S+4 m=10.8M+4m and 7M+2S+3 m=8.6M+3m are obtained.

As described above, according to the computing device 20 according to the second embodiment, the cube computation can be performed at a smaller cost by using Expression (2) than using a common arithmetic expression.

### Third Embodiment

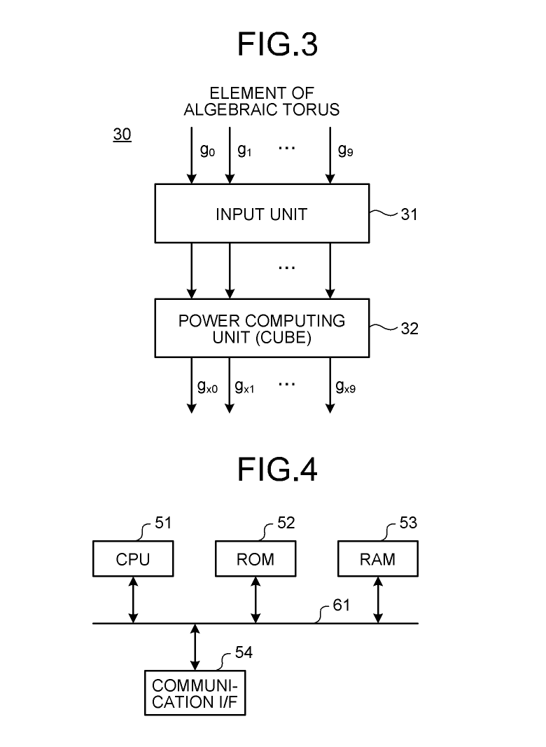

FIG. 3 illustrates the configuration of a computing device 30 according to the third embodiment. The computing device 30 calculates and outputs the cube of an element of an algebraic torus.

The computing device 30 includes an input unit 31 and a power computing unit 32. The input unit 31 inputs an element of an algebraic torus selected from elements of a tenth degree extension field obtained by extending a finite field by a tenth order polynomial.

The input unit 31 inputs an element of the algebraic torus in the form of vector representation. Specifically, an element g of a tenth degree extension field can be expressed by ten coefficients of a polynomial from g₀ to g₉. The input unit 31 inputs the coefficients g₀ to g₉ in the expression.

The power computing unit 32 computes the cube of the input element of the algebraic torus by a preset arithmetic expression. The power computing unit 32 then outputs the result of cube computation in the form of vector representation. In this example, the power computing unit 32 outputs the cube computation result g³ in the form of ten coefficients of the polynomial from gₓ₀ to gₓ₉.

Note that the power computing unit 32 computes the cube of the input element of the algebraic torus, computing the cube being performed on the basis of an arithmetic expression for cubing an element of a tenth degree extension field expressed in the form of vector representation, and the arithmetic expression being satisfied when the element of the tenth degree extension field satisfies the condition for an element of an algebraic torus.

The computing device 30 can compute the cube at a smaller cost by using such an arithmetic expression than using a common arithmetic expression.

The arithmetic expression for cubing an element of the tenth degree extension field can be derived by rearranging an arithmetic expression for cubing an element of the tenth degree extension field expressed in the form of vector representation by an expression derived by substituting expressions representing an element of the tenth degree extension field and Frobenius conjugate elements into the expression representing the condition for an element of an algebraic torus. A specific arithmetic expression for cubing used by the power computing unit 32 will be described below.

Assume that a polynomial for tenth degree extension of a base field F_{q} is a tenth order cyclotomic polynomial. Thus, the tenth degree extension field F_{q̂10} is generated by extending the base field F_{q} by a polynomial expressed by Expression (60). Here, v represents a variable.

v¹⁰+v⁹+v⁸+v⁷+v⁶+v⁵+v⁴+v³+v²+v+1 (60)

In addition, an element of the tenth degree extension field F_{q̂10} is expressed by a normal base of Expression (61). Some Frobenius conjugate elements g^{g}, g^{q̂2}, g^{q̂3}, and g^{q̂4} of the tenth degree extension field F_{q̂10} are expressed by normal bases of Expression (62), Expression (63), Expression (64), and Expression (65).

g=g0·v+g1·v²+g2·v⁴+g3·v⁸+g4·v⁵+g5·v¹⁰+g6·v⁹+g7·v⁷+g8·v³+g9·v⁶ (61)

g^{q}=g9·v+g0·v²+g1·v⁴+g2·v⁸+g3·v⁵+g4·v¹⁰+g5·v⁹+g6·v⁷+g7·v³+g8·v⁶ (62)

g^{q̂2}=g8·v+g9·v²+g0·v⁴+g1·v⁸+g2·v⁵+g3·v¹⁰+g4·v⁹+g5·v⁷+g6·v³+g7·v⁶ (63)

g^{q̂3}=g7·v+g8·v²+g9·v⁴+g0·v⁸+g1·v⁵+g2·v¹⁰+g3·v⁹+g4·v⁷+g5·v³+g6·v⁶ (64)

g^{q̂4}=g6·v+g7·v²+g8·v⁴+g9·v⁸+g0·v⁵+g1·v¹⁰+g2·v⁹+g3·v⁷+g4·v³+g5·v⁶ (65)

Here, q satisfying v^{q}=v², v^{(q̂2)}=v⁴, v_{(q̂3)}=v⁸, v^{(q̂4)}=v⁵, v^{(q̂5)}=v¹⁰, v^{(q̂6)}=v⁹, v^{(q̂7)}=v⁷, v^{(q̂8)}=v³, and v^{(q̂9)}=v⁶ for q mod 11=2 is used.

Note that an element of the algebraic torus is an element that is not included in a subfield in the tenth degree extension field F_{q̂10}. An expression representing the condition of an element of the algebraic torus among elements of the tenth degree extension field F_{q̂10} is g^{q̂4-q̂3+q̂2-q+1}=1. This expression is converted to Expression (66).

g^{(q̂4+q̂2+1})=q^{(q̂3+q)} (66)

The expressions representing an element of the tenth degree extension field F_{q̂10} and the Frobenius conjugate elements are substituted into Expression (66). As a result, the following ten sets of conditional expressions are derived.

coeff(left,v,1)=coeff(right,v,1)

coeff(left,v,2)=coeff(right,v,2)

coeff(left,v,4)=coeff(right,v,4)

coeff(left,v,8)=coeff(right,v,8)

coeff(left,v,5)=coeff(right,v,5)

coeff(left,v,10)=coeff(right,v,10)

coeff(left,v,9)=coeff(right,v,9)

coeff(left,v,7)=coeff(right,v,7)

coeff(left,v,3)=coeff(right,v,3)

coeff(left,v,6)=coeff(right,v,6)

coeff(left, v, 1) on the left-hand side is as expressed by the following expression.

$$- g 1 g 3 g 5 + g 1 g {3}^{2} - g {8}^{2} g 0 + g {0}^{2} g 8 + g 2 g {8}^{2} + g {8}^{2} g 7 - g 2 g {0}^{2} + g 9 g 0 g 8 - g 8 g 0 g 7 - g 0 g 4 g 8 + g 1 g 0 g 8 - g 8 g 0 g 6 + g 1 g 0 g 2 + g 8 g 0 g 5 - g 1 g {0}^{2} + g {9}^{2} g 8 + g {0}^{2} g 7 - g {6}^{2} g 7 - g 8 g {6}^{2} + g {7}^{2} g 6 + g {0}^{2} g 3 - g {8}^{2} g 3 - g 8 g {7}^{2} - g {9}^{2} g 0 - g {0}^{2} g 5 + g 0 g {4}^{2} + g {6}^{2} g 3 + g 9 g {6}^{2} - g 2 g 8 g 6 - g 2 g 4 g 0 + g 8 g 7 g 6 - g 9 g 8 g 5 + g 9 g 0 g 7 - g 9 g 1 g 8 + g 8 g 1 g 7 - g 2 g 8 g 5 + g 0 g 4 g 9 + g 0 g 7 g 6 + g 1 g 4 g 0 + g 8 g 7 g 5 - g 9 g 4 g 8 + g 8 g 5 g 6 + g 7 g 4 g 6 + g 8 g 1 g 6 - g 8 g 3 g 7 + g 8 g 4 g 3 - g 2 g 4 g 8 - g 1 g 0 g 7 + g 9 g 3 g 8 - g 5 g 4 g 7 - g 3 g 7 g 6 - g 0 g 3 g 7 - g 0 g 4 g 3 - g 1 g 0 g 3 - g 1 g 4 g 8 - g 9 g 0 g 5 - g 8 g 1 g 5 + g 3 g 4 g 7 + g 3 g 7 g 5 + 2 g 2 g 0 g 5 + g 2 g 1 g 9 + g 1 g 3 g 8 + g 9 g 2 g 5 + g 8 g 3 g 6 + 2 g 8 g 4 g 5 - g 2 g 1 g 7 - g 2 g 7 g 6 - g 0 g 4 g 5 + 2 g 1 g 0 g 5 + g 9 g 4 g 7 - g 9 g 7 g 5 + g 5 g 3 g 6 - g 3 g 4 g 6 + g 2 g 1 g 3 - g 2 g 3 g 9 + g 2 g 4 g 7 + g 2 g 7 g 5 - g {2}^{2} g 7 - g {4}^{2} g 6 - g 9 g {7}^{2} - g {1}^{2} g 2 - g {4}^{2} g 5 - g {5}^{2} g 6 - g 0 g {5}^{2} - g 1 g {6}^{2} - g {5}^{2} g 7 - g 8 g {3}^{2} - g 9 g {4}^{2} + g {1}^{2} g 4 + g {2}^{2} g 6 + g 0 g {3}^{2} + g 1 g {7}^{2} + g 2 g {4}^{2} - g {3}^{2} g 4 + g {1}^{2} g 7 - g {1}^{2} g 3 + g 9 g {3}^{2} - g {1}^{2} g 6 - g {3}^{2} g 5 + 2 g 3 g 4 g 5 + g 1 g 5 g 6 - g 1 g 7 g 5 + g 2 g 3 g 7 - g 1 g 3 g 9 - g 1 g 4 g 7 + g 9 g 4 g 6 - g 2 g 4 g 6 - g 1 g 3 g 7 - g 9 g 3 g 6 + g 1 g 4 g 6 - g 2 g 3 g 5 + g 1 g 3 g 6 + g {5}^{3}$$

coeff(left, v, 2) on the left-hand side is as expressed by the following expression.

$$- g 1 g 3 g 5 - g {8}^{2} g 0 - g 9 g {8}^{2} + g 2 g {8}^{2} + g {8}^{2} g 7 + g 9 g 2 g 8 + g 1 g 0 g 8 + g 9 g 7 g 8 - g 8 g 0 g 6 + g 9 g 8 g 6 + g 8 g 0 g 5 + g {0}^{2} g 9 - g 1 g {0}^{2} + g {9}^{2} g 8 - g {6}^{2} g 7 - g 8 g {6}^{2} + g {2}^{2} g 8 - g 8 g {7}^{2} + g 0 g {7}^{2} + g {7}^{2} g 4 + g 0 g {4}^{2} - g 2 g 8 g 6 - g 2 g 0 g 9 - g 2 g 4 g 0 - g 9 g 1 g 8 + g 8 g 1 g 7 - g 2 g 8 g 5 - g 2 g 1 g 8 + g 0 g 4 g 9 + g 1 g 0 g 9 + g 8 g 7 g 5 - g 9 g 4 g 8 - g 8 g 4 g 7 - g 8 g 5 g 6 + g 7 g 4 g 6 - g 8 g 3 g 7 + g 8 g 4 g 3 + g 2 g 0 g 3 - g 2 g 4 g 8 + g 2 g 7 g 9 - g 0 g 4 g 7 + g 0 g 7 g 5 - g 9 g 0 g 6 - g 5 g 4 g 7 - g 2 g 3 g 8 - g 0 g 4 g 3 - g 1 g 4 g 8 - g 9 g 0 g 5 - g 9 g 2 g 6 + g 8 g 4 g 6 - g 3 g 7 g 5 + g 2 g 1 g 9 - g 1 g 0 g 6 - g 1 g 4 g 2 - g 9 g 1 g 7 - g 9 g 2 g 5 + g 9 g 7 g 6 + g 8 g 3 g 6 + g 8 g 4 g 5 + 2 g 5 g 4 g 6 + g 2 g 4 g 9 + g 2 g 7 g 6 + g 0 g 3 g 6 + g 1 g 0 g 5 + g 9 g 4 g 7 + 2 g 9 g 5 g 6 + g 8 g 3 g 5 - g 3 g 4 g 6 + g 2 g 1 g 3 + g 2 g 4 g 7 + g 2 g 7 g 5 + g 9 g 1 g 6 - g 9 g 3 g 7 + g {1}^{2} g 8 - g {2}^{2} g 7 - g {4}^{2} g 6 - g 9 g {7}^{2} - g {1}^{2} g 2 - g {4}^{2} g 5 - g {5}^{2} g 6 - g 0 g {5}^{2} - g 1 g {6}^{2} - g {2}^{2} g 4 - g 2 g {7}^{2} - g {5}^{2} g 7 - g 8 g {3}^{2} - g {9}^{2} g 1 - g 9 g {4}^{2} + g {1}^{2} g 4 - g {2}^{2} g 3 - g 2 g {4}^{2} - g {9}^{2} g 4 + g {1}^{2} g 9 + g {2}^{2} g 5 + g {3}^{2} g 7 + g 1 g {4}^{2} + g {9}^{2} g 3 - g {1}^{2} g 3 + g {5}^{2} g 3 - g {1}^{2} g 6 + g 1 g {5}^{2} - g 1 g 5 g 6 + 2 g 2 g 1 g 6 + g 2 g 4 g 3 - g 9 g 1 g 5 + g 2 g 1 g 5 - g 2 g 4 g 6 - g 9 g 3 g 6 + g 9 g 4 g 5 - g 9 g 3 g 5 + 2 g 1 g 3 g 6 - g 1 g 4 g 5 + g {6}^{3}$$

coeff(left, v, 4) on the left-hand side is as expressed by the following expression.

$$- g 1 g 3 g 5 - g {8}^{2} g 0 - g 9 g {8}^{2} - g 2 g {0}^{2} + g 9 g 0 g 8 + g 8 g 0 g 7 - g 2 g 0 g 8 + g 9 g 2 g 8 - g 0 g 4 g 8 + g 0 g 3 g 8 + g 1 g 0 g 2 + g 9 g 8 g 6 + g 8 g 0 g 5 + g {0}^{2} g 9 + g {8}^{2} g 5 + g {0}^{2} g + g {8}^{2} g 1 + g {9}^{2} g 8 - g {6}^{2} g 7 - g 8 g {6}^{2} + g {2}^{2} g 0 - g {8}^{2} g 3 - g 8 g {7}^{2} + g 8 g {4}^{2} - g {9}^{2} g 0 - g {0}^{2} g 5 + g {1}^{2} g 0 + g {6}^{2} g 4 + g {2}^{2} g 9 - g 2 g 0 g 9 - g 9 g 8 g 5 + g 9 g 0 g 7 + g 2 g 0 g 7 + 2 g 0 g 7 g 6 + g 8 g 7 g 5 - g 9 g 4 g 8 - g 8 g 5 g 6 + g 8 g 1 g 6 + g 8 g 3 g 7 + 2 g 5 g 7 g 6 + g 2 g 0 g 3 + g 0 g 3 g 9 - g 0 g 4 g 7 + g 0 g 5 g 6 - g 1 g 0 g 7 - g 5 g 4 g 7 - g 2 g 0 g 6 - g 0 g 3 g 7 - g 1 g 0 g 3 - g 9 g 0 g 5 - g 8 g 1 g 5 - g 8 g 4 g 6 - g 3 g 7 g 5 + g 2 g 1 g 9 - g 0 g 4 g 6 - g 1 g 0 g 6 - g 9 g 1 g 7 - g 9 g 2 g 5 - g 9 g 7 g 6 + g 8 g 3 g 6 - g 2 g 1 g 7 - g 2 g 7 g 6 - g 0 g 3 g 6 + g 1 g 0 g 5 + g 9 g 4 g 7 + g 9 g 5 g 6 + g 9 g 7 g 5 + g 8 g 3 g 5 - g 2 g 3 g 9 + 2 g 2 g 4 g 7 - g 2 g 5 g 6 + g 0 g 3 g 5 + g 9 g 1 g 6 - g 9 g 3 g 7 - g 9 g 4 g 3 - g {2}^{2} g 7 + g 2 g {6}^{2} - g 9 g {7}^{2} - g {1}^{2} g 2 - g {5}^{2} g 6 - g 0 g {5}^{2} - g 1 g {6}^{2} - g {2}^{2} g 4 - g 2 g {7}^{2} - g {5}^{2} g 7 - g 8 g {3}^{2} - g {9}^{2} g 1 - g 9 g {4}^{2} - g {2}^{2} g 3 + g {2}^{2} g 5 - g {3}^{2} g 4 + g {9}^{2} g 3 + g {3}^{2} g 6 + g 2 g {5}^{2} + g {5}^{2} g 3 + g {3}^{2} g 5 + g 1 g {5}^{2} + g 3 g 4 g 5 + g 2 g 1 g 6 + 2 g 2 g 3 g 7 + g 2 g 4 g 3 + g 1 g 4 g 7 + g 9 g 4 g 6 - g 2 g 4 g 6 + g 1 g 4 g 3 - g 9 g 3 g 6 + g 9 g 4 g 5 + g 2 g 3 g 6 - g 9 g 3 g 5 - g 2 g 3 g 5 - g 1 g 4 g 5 + g {7}^{3}$$

coeff(left, v, 8) on the left-hand side is as expressed by the following expression.

$$g {1}^{2} g 5 + g 1 g {3}^{2} + g {8}^{3} - g {8}^{2} g 0 - g 9 g {8}^{2} - g 2 g {0}^{2} - g 8 g 0 g 7 - g 2 g 0 g 8 - g 0 g 4 g 8 + g 1 g 0 g 8 + g 8 g 0 g 6 + g 9 g 8 g 6 + g 8 g 0 g 5 + g {0}^{2} g 9 + g {0}^{2} g 4 - g 1 g {0}^{2} - g {6}^{2} g 7 - g 8 g {6}^{2} - g {8}^{2} g 3 - g 8 g {7}^{2} - g {9}^{2} g 0 + g {9}^{2} g 6 + g {1}^{2} g 0 + g {4}^{2} g 7 + g 0 g {4}^{2} + g 5 g {7}^{2} + g {6}^{2} g 4 + g {9}^{2} g 2 + g 3 g {7}^{2} + g {6}^{2} g 3 + 2 g 8 g 7 g 6 + g 9 g 0 g 7 + g 9 g 1 g 8 + 2 g 8 g 1 g 7 + g 2 g 8 g 5 + g 2 g 0 g 7 - g 2 g 1 g 8 + g 0 g 7 g 6 + g 1 g 0 g 9 + g 1 g 4 g 0 + g 9 g 4 g 8 - g 8 g 5 g 6 - g 8 g 3 g 7 + 2 g 8 g 4 g 3 + g 2 g 0 g 3 + g 2 g 7 g 9 + g 0 g 3 g 9 - g 0 g 4 g 7 + g 0 g 5 g 6 + g 0 g 7 g 5 - g 9 g 9 g 6 - g 3 g 7 g 6 - g 2 g 3 g 8 - g 0 g 4 g 3 - g 1 g 0 g 3 - g 1 g 4 g 8 - g 9 g 0 g 5 - g 9 g 2 g 6 - g 8 g 1 g 5 - g 8 g 4 g 6 + g 3 g 4 g 7 - g 3 g 7 g 5 - g 0 g 4 g 6 - g 1 g 0 g 6 + g 1 g 3 g 8 - g 1 g 4 g 2 - g 9 g 7 g 6 + g 5 g 4 g 6 - g 2 g 1 g 7 - g 0 g 3 g 6 - g 0 g 4 g 5 + g 9 g 4 g 7 - g 9 g 7 g 5 + 2 g 8 g 3 g 5 - g 3 g 4 g 6 + g 1 g 7 g 6 + g 2 g 1 g 3 - g 2 g 5 g 6 + g 1 g 4 g 9 + g 9 g 1 g 6 - g {4}^{2} g 6 + g {2}^{2} g 1 + g 2 g {6}^{2} - g 9 g {7}^{2} - g {4}^{2} g 5 - g 0 g {5}^{2} - g 1 g {6}^{2} - g 2 g {7}^{2} - g 8 g {3}^{2} - g {9}^{2} g 1 - g 9 g {4}^{2} + g 0 g {3}^{2} - g {2}^{2} g 3 - g {9}^{2} g 4 - g {3}^{2} g 4 + g 9 g {5}^{2} - g {1}^{2} g 3 + g {3}^{2} g 6 - g {1}^{2} g 6 - g {3}^{2} g 5 + g 3 g 4 g 5 - g 1 g 7 g 5 + g 2 g 1 g 6 + g 2 g 3 g 7 - g 1 g 3 g 9 - g 1 g 4 g 7 - g 9 g 1 g 5 + g 9 g 4 g 6 - g 2 g 4 g 6 - g 1 g 3 g 7 + g 1 g 4 g 3 + g 2 g 4 g 5 + g 1 g 4 g 6$$

coeff(left, v, 5) on the left-hand side is as expressed by the following expression.

$$g {1}^{2} g 5 - g {8}^{2} g 0 - g 9 g {8}^{2} + g {8}^{2} g 6 - g 2 g {0}^{2} - g 8 g 0 g 7 + 2 g 9 g 2 g 8 + g 1 g 0 g 8 + 2 g 9 g 7 g 8 - g 8 g 0 g 6 + g 2 g 7 g 8 + g 0 g 3 g 8 + g 1 g 0 g 2 + g 8 g 0 g 5 - g 1 g {0}^{2} + g {0}^{2} g 7 + g {8}^{2} g 4 + g {0}^{2} g 3 + g 0 g {6}^{2} - g {8}^{2} g 3 - g 8 g {7}^{2} + g {7}^{2} g 4 - g {9}^{2} g 0 - g {0}^{2} g 5 + g {1}^{2} g 0 + g {4}^{2} g 7 + g 5 g {7}^{2} + g 3 g {7}^{2} - g 2 g 8 g 6 + g 2 g 0 g 9 - g 2 g 4 g 0 + g 9 g 0 g 7 - g 9 g 1 g 8 + g 8 g 1 g 7 - g 2 g 8 g 5 + g 2 g 0 g 7 + g 1 g 4 g 0 - g 9 g 4 g 8 - g 8 g 4 g 7 + g 8 g 1 g 6 + g 8 g 4 g 3 + g 5 g 7 g 6 - g 2 g 4 g 8 + g 0 g 7 g 5 - g 1 g 0 g 7 - g 5 g 4 g 7 - g 3 g 7 g 6 - g 2 g 0 g 6 - g 2 g 3 g 8 - g 0 g 3 g 7 + g 9 g 0 g 5 - g 9 g 2 g 6 - g 8 g 1 g 5 - g 8 g 4 g 6 - g 3 g 7 g 5 + g 2 g 0 g 5 + g 2 g 1 g 9 - g 1 g 0 g 6 + g 1 g 3 g 8 - g 1 g 4 g 2 + g 9 g 1 g 7 - g 9 g 2 g 5 - g 9 g 7 g 6 + g 8 g 4 g 5 + g 5 g 4 g 6 - g 2 g 1 g 7 + g 2 g 4 g 9 - g 9 g 7 g 5 + g 5 g 3 g 6 + g 1 g 7 g 6 - g 2 g 3 g 9 + g 2 g 7 g 5 + g 9 g 1 g 6 - g 9 g 4 g 3 - g {2}^{2} g 7 - g {4}^{2} g 6 + g {2}^{2} g 1 + g 8 g {5}^{2} - g 9 g {7}^{2} - g {1}^{2} g 2 - g {4}^{2} g 5 - g {5}^{2} g 6 - g 0 g {5}^{2} - g 1 g {6}^{2} - g {2}^{2} g 4 - g 2 g {7}^{2} - g {5}^{2} g 7 - g {9}^{2} g 1 - g 9 g {4}^{2} + g {2}^{2} g 6 + g 2 g {4}^{2} - g {9}^{2} g 4 + g 1 g {4}^{2} - g {3}^{2} g 4 - g {1}^{2} g 3 + g 1 g {5}^{2} + g 2 g {3}^{2} - g 1 g 5 g 6 - g 1 g 7 g 5 + g 2 g 3 g 7 + g 2 g 4 g 3 - g 1 g 3 g 9 - g 1 g 4 g 7 - g 9 g 1 g 5 + 2 g 9 g 4 g 6 + g 2 g 1 g 5 + g 1 g 4 g 3 + g 9 g 3 g 6 + 2 g 9 g 4 g 5 + g 2 g 4 g 5 - g 2 g 3 g 5 - g 1 g 4 g 5 + g {9}^{3}$$

coeff(left, v, 10) on the left-hand side is as expressed by the following expression.

$$- g 1 g 3 g 5 + g {0}^{3} - g {8}^{2} g 0 - g 9 g {8}^{2} + g {8}^{2} g 6 - g 2 g {0}^{2} + 2 g 9 g 0 g 8 - g 8 g 0 g 7 + g 2 g 0 g 8 + g 9 g 2 g 8 + g 1 g 0 g 8 - g 8 g 0 g 6 + g 2 g 7 g 8 + g {8}^{2} g 5 - g 1 g {0}^{2} - g {6}^{2} g 7 + g {8}^{2} g 4 - g 8 g {6}^{2} - g {8}^{2} g 3 - g {9}^{2} g 0 - g {0}^{2} g 5 + g 9 g {6}^{2} + g {9}^{2} g 7 - g 2 g 8 g 6 - g 2 g 0 g 9 - g 2 g 4 g 0 + g 8 g 7 g 6 - g 9 g 8 g 5 - g 9 g 1 g 8 - g 2 g 8 g 5 + g 2 g 0 g 7 - g 2 g 1 g 8 - g 8 g 4 g 7 - g 8 g 5 g 6 + g 7 g 4 g 6 + g 8 g 1 g 6 + g 8 g 4 g 3 + g 5 g 7 g 6 + g 2 g 0 g 3 + g 2 g 7 g 9 + 2 g 0 g 3 g 9 + g 0 g 4 g 7 + 2 g 0 g 5 g 6 + 2 g 0 g 7 g 5 + g 9 g 3 g 8 - g 2 g 0 g 6 - g 2 g 3 g 8 - g 0 g 3 g 7 - g 0 g 4 g 3 + g 1 g 0 g 3 - g 1 g 4 g 8 - g 9 g 0 g 5 - g 9 g 2 g 6 - g 8 g 4 g 6 + g 2 g 1 g 9 + g 1 g 0 g 6 + g 1 g 3 g 8 - g 9 g 1 g 7 + g 8 g 3 g 6 - g 2 g 1 g 7 + g 2 g 4 g 9 - g 2 g 7 g 6 - g 0 g 3 g 6 - g 0 g 4 g 5 + g 9 g 5 g 6 - g 9 g 7 g 5 + g 5 g 3 g 6 - g 3 g 4 g 6 - g 2 g 1 g 3 - g 2 g 5 g 6 + g 0 g 3 g 5 + g 1 g 4 g 9 + g 9 g 1 g 6 - g 9 g 3 g 7 - g 9 g 4 g 3 + g {1}^{2} g 8 + g {2}^{2} g 1 + g 2 g {6}^{2} + g 3 g {4}^{2} + g 8 g {5}^{2} + g {9}^{2} g 5 - g {1}^{2} g 2 - g {4}^{2} g 5 - g {5}^{2} g 6 - g 0 g {5}^{2} - g 1 g {6}^{2} - g {2}^{2} g 4 - g 2 g {7}^{2} - g {5}^{2} g 7 - g 8 g {3}^{2} - g {9}^{2} g 1 + g {1}^{2} g 4 + g {2}^{2} g 6 + g 1 g {7}^{2} - g {2}^{2} g 3 - g {9}^{2} g 4 + g {3}^{2} g 7 - g {1}^{2} g 3 + g 2 g {5}^{2} + g {5}^{2} g 3 - g {1}^{2} g 6 - g {3}^{2} g 5 + g 2 g {3}^{2} + g 3 g 4 g 5 + g 2 g 1 g 5 - g 1 g 3 g 7 - g 9 g 3 g 6 + g 9 g 4 g 5 + g 2 g 3 g 6 + g 2 g 4 g 5 - g 9 g 3 g 5 - g 2 g 3 g 5 + g 1 g 3 g 6$$

coeff(left, v, 9) on the left-hand side is as expressed by the following expression.

$$- g 1 g 3 g 5 + g {0}^{2} g 8 + g 2 g {8}^{2} - g 2 g {0}^{2} - g 2 g 0 g 8 - g 0 g 4 g 8 + g 9 g 7 g 8 - g 8 g 0 g 6 + g 0 g 3 g 8 - g 1 g {0}^{2} - g {6}^{2} g 7 - g 8 g {6}^{2} - g {8}^{2} g 3 - g 8 g {7}^{2} + g {0}^{2} g 6 + g 0 g {7}^{2} + g 8 g {4}^{2} - g {9}^{2} g 0 + g {9}^{2} g 6 - g {0}^{2} g 5 + g {6}^{2} g 4 + g {2}^{2} g 9 + g 3 g {7}^{2} + g {6}^{2} g 3 + g 9 g {6}^{2} + g {9}^{2} g 7 - g 2 g 0 g 9 + g 8 g 7 g 6 - g 9 g 8 g 5 - g 9 g 1 g 8 + g 2 g 0 g 7 + g 0 g 4 g 9 + g 0 g 7 g 6 + 2 g 1 g 0 g 9 + 2 g 1 g 4 g 0 + g 8 g 7 g 5 + g 7 g 4 g 6 + 2 g 8 g 1 g 6 - g 8 g 3 g 7 + g 2 g 0 g 3 - g 2 g 4 g 8 + g 2 g 7 g 9 + g 0 g 3 g 9 - g 0 g 4 g 7 + g 0 g 5 g 6 - g 9 g 0 g 6 + g 9 g 3 g 8 - g 5 g 4 g 7 - g 3 g 7 g 6 - g 2 g 3 g 8 - g 0 g 3 g 7 - g 1 g 0 g 3 - g 1 g 4 g 8 + g 8 g 1 g 5 + g 3 g 4 g 7 + g 2 g 0 g 5 + g 2 g 1 g 9 - g 0 g 4 g 6 - g 1 g 0 g 6 + g 1 g 3 g 8 + g 1 g 4 g 2 - g 9 g 1 g 7 - g 9 g 2 g 5 - g 9 g 7 g 6 + g 5 g 4 g 6 + g 2 g 1 g 7 + g 2 g 4 g 9 - g 0 g 4 g 5 + g 9 g 4 g 7 - g 9 g 7 g 5 + g 5 g 3 g 6 - g 3 g 4 g 6 + 2 g 1 g 7 g 6 - g 2 g 3 g 9 + g 2 g 4 g 7 + g 0 g 3 g 5 - g 9 g 3 g 7 - g 9 g 4 g 3 - g {2}^{2} g 7 - g {4}^{2} g 6 + g 3 g {4}^{2} + g {9}^{2} g 5 - g 9 g {7}^{2} - g {1}^{2} g 2 - g {5}^{2} g 6 - g 1 g {6}^{2} - g {2}^{2} g 4 - g 2 g {7}^{2} - g {9}^{2} g 1 - g 9 g {4}^{2} - g {2}^{2} g 3 - g {9}^{2} g 4 + g {2}^{2} g 5 + g {3}^{2} g 7 - g {3}^{2} g 4 + g {5}^{2} g 4 - g {1}^{2} g 3 - g {1}^{2} g 6 - g {3}^{2} g 5 + g 2 g {3}^{2} - g 1 g 5 g 6 + g 2 g 4 g 3 + g 1 g 3 g 9 - g 1 g 4 g 7 - g 2 g 4 g 6 - g 1 g 3 g 7 - g 1 g 4 g 3 - g 9 g 3 g 6 + g 9 g 4 g 5 + g 2 g 3 g 6 + g 1 g 4 g 6 - g 1 g 4 g 5 + g {1}^{3}$$

coeff(left, v, 7) on the left-hand side is as expressed by the following expression.

$$- g {8}^{2} g 0 + g {0}^{2} g 8 - g 9 g {8}^{2} - g 2 g {0}^{2} + g 9 g 0 g 8 - g 8 g 0 g 7 - g 2 g 0 g 8 - g 0 g 4 g 8 + g 9 g 7 g 8 - g 8 g 0 g 6 + 2 g 2 g 7 g 8 + g 0 g 3 g 8 + 2 g 1 g 0 g 2 + g 9 g 8 g 6 + g 8 g 0 g 5 - g 1 g {0}^{2} + g {8}^{2} g 1 + g {0}^{2} g 7 - g {6}^{2} g 7 + g {8}^{2} g 4 - g {8}^{2} g 3 - g 8 g {7}^{2} + g {0}^{2} g 6 + g 0 g {7}^{2} + g 5 g {6}^{2} + g {7}^{2} g 4 + g 8 g {4}^{2} - g {0}^{2} g 5 + g 5 g {7}^{2} - g 2 g 0 g 9 + g 2 g 4 g 0 + g 8 g 1 g 7 - g 2 g 8 g 5 + g 0 g 4 g 9 + g 1 g 4 g 0 + g 8 g 7 g 5 - g 9 g 4 g 8 - g 8 g 4 g 7 - g 8 g 5 g 6 + g 7 g 4 g 6 + g 5 g 7 g 6 + g 2 g 0 g 3 - g 2 g 4 g 8 + 2 g 2 g 7 g 9 - g 0 g 4 g 7 + g 0 g 5 g 6 - g 1 g 0 g 7 - g 9 g 0 g 6 - g 5 g 4 g 7 + g 2 g 3 g 8 - g 0 g 4 g 3 - g 1 g 0 g 3 - g 1 g 4 g 8 + g 9 g 2 g 6 - g 8 g 1 g 5 + g 3 g 4 g 7 + g 3 g 7 g 5 + g 1 g 3 g 8 - g 1 g 4 g 2 - g 9 g 1 g 7 - g 9 g 2 g 5 + g 8 g 4 g 5 - g 2 g 1 g 7 + g 2 g 4 g 9 - g 2 g 7 g 6 - g 0 g 3 g 6 - g 0 g 4 g 5 + g 1 g 0 g 5 + g 8 g 3 g 5 + g 1 g 7 g 6 - g 2 g 5 g 6 + g 2 g 7 g 5 + g 0 g 3 g 5 + g 1 g 4 g 9 - g 9 g 4 g 3 - g {2}^{2} g 7 - g {4}^{2} g 6 + g 3 g {4}^{2} - g 9 g {7}^{2} - g {1}^{2} g 2 - g {4}^{2} g 5 - g 0 g {5}^{2} - g {2}^{2} g 4 - g 2 g {7}^{2} - g {5}^{2} g 7 - g 8 g {3}^{2} + g 0 g {3}^{2} - g {2}^{2} g 3 - g {9}^{2} g 4 + g {1}^{2} g 9 - g {3}^{2} g 4 + g {9}^{2} g 3 + g {1}^{2} g 7 + g {5}^{2} g 4 + g 9 g {5}^{2} - g {1}^{2} g 3 + g {3}^{2} g 6 - g {1}^{2} g 6 - g {3}^{2} g 5 + g 3 g 4 g 5 - g 1 g 5 g 6 - g 1 g 7 g 5 - g 1 g 3 g 9 - g 9 g 1 g 5 + 2 g 2 g 1 g 5 - g 2 g 4 g 6 + g 1 g 4 g 3 + g 2 g 4 g 5 + g 1 g 4 g 6 - g 9 g 3 g 5 + g 2 g 3 g 5 + g 1 g 3 g 6 + g {2}^{3}$$

coeff(left, v, 3) on the left-hand side is as expressed by the following expression.

$$g 1 g 3 g 5 - g {8}^{2} g 0 - g 9 g {8}^{2} + g {8}^{2} g 6 + g 9 g 0 g 8 - g 2 g 0 g 8 + g 9 g 2 g 8 + g 2 g 7 g 8 + 2 g 0 g 3 g 8 + g 9 g 8 g 6 + g {8}^{2} g 5 + g {0}^{2} g 4 + g {8}^{2} g 1 - g 8 g {6}^{2} + g {7}^{2} g 6 + g {2}^{2} g 8 + g 0 g {6}^{2} + g {2}^{2} g 0 - g {8}^{2} g 3 - g 8 g {7}^{2} + g 5 g {6}^{2} - g {9}^{2} g 0 - g {0}^{2} g 5 + g {4}^{2} g 7 + g {9}^{2} g 2 - g 2 g 8 g 6 - g 2 g 4 g 0 + g 8 g 7 g 6 - g 9 g 8 g 5 + g 9 g 0 g 7 - g 9 g 1 g 8 - g 2 g 1 g 8 + g 1 g 0 g 9 + g 8 g 7 g 5 - g 8 g 5 g 6 - g 8 g 3 g 7 - g 1 g 0 g 7 + 2 g 9 g 3 g 8 - g 3 g 7 g 6 - g 2 g 0 g 6 - g 2 g 3 g 8 + g 0 g 3 g 7 - g 1 g 0 g 3 - g 9 g 0 g 5 - g 9 g 2 g 6 - g 8 g 1 g 5 - g 8 g 4 g 6 - g 3 g 7 g 5 + g 2 g 0 g 5 - g 0 g 4 g 6 - g 1 g 4 g 2 - g 9 g 1 g 7 - g 9 g 2 g 5 - g 9 g 7 g 6 + g 8 g 3 g 6 + g 8 g 4 g 5 + g 5 g 4 g 6 + g 2 g 4 g 9 - g 2 g 7 g 6 - g 0 g 3 g 6 - g 0 g 4 g 5 + g 1 g 0 g 5 + g 9 g 5 g 6 + g 5 g 3 g 6 + g 3 g 4 g 6 + g 1 g 7 g 6 + 2 g 2 g 1 g 3 + g 2 g 4 g 7 + g 2 g 7 g 5 + g 0 g 3 g 5 + g 1 g 4 g 9 + g 9 g 1 g 6 + g 9 g 4 g 3 + g {1}^{2} g 8 - g {2}^{2} g 7 - g {4}^{2} g 6 + g {9}^{2} g 5 - g {1}^{2} g 2 - g {4}^{2} g 5 - g {5}^{2} g 6 - g 1 g {6}^{2} - g {2}^{2} g 4 - g {5}^{2} g 7 - g 8 g {3}^{2} - g {9}^{2} g 1 - g 9 g {4}^{2} - g {2}^{2} g 3 - g {9}^{2} g 4 + g {1}^{2} g 9 + g 1 g {4}^{2} - g {3}^{2} g 4 + g {1}^{2} g 7 + g {5}^{2} g 4 + g 9 g {5}^{2} - g {1}^{2} g 3 - g {1}^{2} g 6 - g {3}^{2} g 5 - g 1 g 5 g 6 + g 2 g 1 g 6 - g 1 g 3 g 9 - g 1 g 4 g 7 - g 9 g 1 g 5 + g 9 g 4 g 6 + g 2 g 1 g 5 + g 1 g 4 g 3 - g 9 g 3 g 6 + 2 g 2 g 3 g 6 + g 2 g 4 g 5 + g 1 g 4 g 6 - g 9 g 3 g 5 - g 2 g 3 g 5 - g 1 g 4 g 5 + g {3}^{3}$$

coeff(left, v, 6) on the left-hand side is as expressed by the following expression.

$$- g 1 g 3 g 5 - g {1}^{2} g 5 + g 1 g {3}^{2} - g 9 g {8}^{2} + g {8}^{2} g 7 - g 2 g {0}^{2} - g 8 g 0 g 7 - g 2 g 0 g 8 + g 1 g 0 g 8 + g 9 g 7 g 8 + g 2 g 7 g 8 + g 1 g 0 g 2 + g 9 g 8 g 6 - g 1 g {0}^{2} - g {6}^{2} g 7 - g 8 g {6}^{2} + g {7}^{2} g 6 + g {0}^{2} g 3 + g {2}^{2} g 8 + g 0 g {6}^{2} + g {2}^{2} g 0 + g {0}^{2} g 6 + g 5 g {6}^{2} - g {9}^{2} g 0 + g {9}^{2} g 6 - g {0}^{2} g 5 + g {9}^{2} g 2 + g {2}^{2} g 9 + g {9}^{2} g 7 - g 2 g 0 g 9 - g 2 g 4 g 0 + g 9 g 0 g 7 - g 2 g 8 g 5 + g 2 g 0 g 7 - g 2 g 1 g 8 + 2 g 0 g 4 g 9 + g 0 g 7 g 6 + g 1 g 0 g 9 - g 9 g 4 g 8 - g 8 g 4 g 7 + g 7 g 4 g 6 - g 8 g 3 g 7 + g 5 g 7 g 6 + g 0 g 3 g 9 - g 0 g 4 g 7 + g 0 g 7 g 5 - g 9 g 0 g 6 + g 9 g 3 g 8 + g 5 g 4 g 7 - g 2 g 0 g 6 - g 0 g 3 g 7 + g 1 g 4 g 8 - g 9 g 2 g 6 - g 8 g 4 g 6 + 2 g 3 g 4 g 7 + g 2 g 0 g 5 - g 0 g 4 g 6 - g 1 g 0 g 6 - g 1 g 4 g 2 - g 9 g 7 g 6 + g 8 g 3 g 6 - g 2 g 7 g 6 - g 0 g 3 g 6 + g 0 g 4 g 5 + g 9 g 4 g 7 + g 9 g 5 g 6 - g 9 g 7 g 5 + g 8 g 3 g 5 + g 5 g 3 g 6 - g 3 g 4 g 6 - g 2 g 3 g 9 - g 2 g 5 g 6 + g 2 g 7 g 5 + g 0 g 3 g 5 + 2 g 1 g 4 g 9 - g 9 g 3 g 7 - g 9 g 4 g 3 - g {2}^{2} g 7 - g {4}^{2} g 6 + g 8 g {5}^{2} - g 9 g {7}^{2} - g {4}^{2} g 5 - g {5}^{2} g 6 - g 0 g {5}^{2} - g {2}^{2} g 4 - g 2 g {7}^{2} - g {5}^{2} g 7 - g 8 g {3}^{2} - g {9}^{2} g 1 - g 9 g {4}^{2} + g 1 g {7}^{2} - g {2}^{2} g 3 - g {9}^{2} g 4 - g {3}^{2} g 4 + g 2 g {5}^{2} + g 9 g {3}^{2} - g {1}^{2} g 6 - g {3}^{2} g 5 - g 1 g 5 g 6 - g 1 g 7 g 5 + g 2 g 1 g 6 + g 2 g 3 g 7 + 2 g 2 g 4 g 3 - g 1 g 3 g 9 - g 1 g 4 g 7 + g 2 g 4 g 6 - g 1 g 3 g 7 + g 2 g 3 g 6 + g 2 g 4 g 5 + g 1 g 4 g 6 - g 2 g 3 g 5 + g 1 g 3 g 6 + g {4}^{3}$$

coeff(right, v, 1) on the right-hand side is as expressed by the following expression.

−g8g5−g9g6−g0g7−g1g8−g0g3−g1g4−g2g5−g3g6−g7g4+g7g3+g5²+g1g6+g8g4+g0g2+g3g4+g6g8+g0g1

coeff(right, v, 2) on the right-hand side is as expressed by the following expression.

g6²+g8g4+g4g5+g3g1+g7g9+g9g5+g2g7+g2g1−g8g5−g9g6−g0g7−g1g8−g9g2−g1g4−g2g5−g3g6−g7g4

coeff(right, v, 4) on the right-hand side is as expressed by the following expression.

g7²+g0g6+g6g5+g3g2+g9g5+g2g4+g3g8+g0g8+g8g5+g9g6+g0g7−g1g8−g9g2−g0g3−g2g5−g3g6−g7g4

coeff(right, v, 8) on the right-hand side is as expressed by the following expression.

g7g1+g7g6+g3g5+g3g4+g9g4+g8²+g1g9+g0g6−g8g5−g9g6−g0g7−g1g8−g9g2−g0g3−g1g4−g3g6−g7g4

coeff(right, v, 5) on the right-hand side is as expressed by the following expression.

g6g4+g2g8+g7g1+g4g5+g9²+g8g7+g0g5+g0g2−g8g5−g9g6−g0g7−g1g8−g9g2−g0g3−g1g4−g2g5−g7g4

coeff(right, v, 10) on the right-hand side is as expressed by the following expression.

g6g5+g0²+g8g9+g5g7+g3g1+g2g8+g1g6+g3g9−g8g5−g9g6−g0g7−g1g8−g9g2−g0g3−g1g4−g2g5−g3g6

coeff(right, v, 9) on the right-hand side is as expressed by the following expression.

g6g8+g7g6+g2g7+g1²+g9g0+g2g4+g0g4+g3g9−g9g6−g0g7−g1g8−g9g2−g0g3−g1g4−g2g5−g3g6−g7g4

coeff(right, v, 7) on the right-hand side is as expressed by the following expression.

g8g7+g3g8+g0g1+g0g4+g5g1+g7g9+g3g5+g2²−g8g5−g0g7−g1g8−g9g2−g0g3−g1g4−g2g5−g3g6−g7g4

coeff(right, v, 3) on the right-hand side is as expressed by the following expression.

g0g8+g2g6+g6g4+g3²+g9g4+g2g1+g8g9+g5g1−g8g5−g9g6−g1g8−g9g2−g0g3−g1g4−g2g5−g3g6−g7g4

coeff(right, v, 6) on the right-hand side is as expressed by the following expression.

g9g0+g4²+g0g5+g5g7+g2g6+g1g9+g7g3+g3g2−g8g5−g9g6−g0g7−g9g2−g0g3−g1g4−g2g5−g3g6−g7g4

A common arithmetic expression of the cube g³ of the element g of the tenth degree extension field F_{q̂10} expressed in the form of vector representation is expressed as in Expression (67).

$${v}^{3} = coeff ( cube , v , 1 ) \times v + coeff ( cube , v , 2 ) \times {v}^{2} + coeff ( cube , v , 4 ) \times {v}^{4} + coeff ( cube , v , 8 ) \times {v}^{8} + coeff ( cube , v , 5 ) \times {v}^{5} + coeff ( cube , v , 10 ) \times {v}^{10} + coeff ( cube , v , 9 ) \times {v}^{9} + coeff ( cube , v , 7 ) \times {v}^{7} + coeff ( cube , v , 3 ) \times {v}^{3} + coeff ( cube , v , 6 ) \times {v}^{6} \qquad ( 67 )$$

coeff(cube, v, 1) is as expressed by the following expression.

$$3 g 9 g {8}^{2} - 6 g 8 g 0 g 7 + 6 g 0 g 3 g 8 - 3 g {8}^{2} g 4 + 3 g {7}^{2} g 6 - 3 g {2}^{2} g 8 - 3 g {0}^{2} g 6 + 3 g {0}^{2} g 5 - 3 g 0 g {4}^{2} + 3 g {6}^{2} g 4 - 3 g 3 g {7}^{2} - 6 g 2 g 0 g 9 - 6 g 9 g 1 g 8 + 6 g 8 g 1 g 7 + 6 g 2 g 0 g 7 + 6 g 0 g 4 g 9 - 6 g 8 g 5 g 6 + 6 g 2 g 4 g 8 - 6 g 5 g 4 g 7 - 6 g 1 g 0 g 3 + 6 g 2 g 1 g 9 + 6 g 1 g 0 g 6 - 6 g 1 g 4 g 2 - 6 g 9 g 7 g 6 + 6 g 9 g 7 g 5 - 6 g 3 g 4 g 6 + 6 g 2 g 5 g 6 - 3 g 2 g {6}^{2} + 3 g 8 g {5}^{2} - 3 g {9}^{2} g 5 + 3 g {3}^{2} g 7 + 3 g 1 g {4}^{2} - 3 g {1}^{2} g 7 + 3 g {1}^{2} g 3 - 3 g 9 g {3}^{2} - 3 g 1 g {5}^{2} + 6 g 3 g 4 g 5 + 6 g 9 g 3 g 6 - 6 g 2 g 3 g 5 + g {2}^{3}$$

coeff(cube, v, 2) is as expressed by the following expression.

$$3 g {8}^{2} g 7 - 6 g 8 g 0 g 7 + 6 g 9 g 2 g 8 + 6 g 8 g 0 g 6 - 3 g {8}^{2} g 4 - 3 g {2}^{2} g 8 - 3 g {0}^{2} g 6 + 3 g 8 g {4}^{2} + 3 g {9}^{2} g 0 - 3 g 0 g {4}^{2} + 3 g 5 g {7}^{2} - 3 g 3 g {7}^{2} + 3 g 9 g {6}^{2} - 6 g 2 g 0 g 9 - 6 g 9 g 1 g 8 - 6 g 8 g 5 g 6 + 6 g 2 g 0 g 3 + 6 g 0 g 4 g 7 - 6 g 5 g 4 g 7 + 6 g 3 g 7 g 6 - 6 g 1 g 0 g 3 + 6 g 1 g 3 g 8 - 6 g 1 g 4 g 2 - 6 g 9 g 7 g 6 + 6 g 5 g 4 g 6 + 6 g 2 g 1 g 7 + 6 g 1 g 0 g 5 - 6 g 3 g 4 g 6 + 6 g 1 g 4 g 9 - 3 g 2 g {6}^{2} - 3 g {9}^{2} g 5 + 3 g {2}^{2} g 4 - 3 g {1}^{2} g 7 + 3 g 2 g {5}^{2} - 3 g 9 g {3}^{2} + 3 g {1}^{2} g 6 - 3 g 1 g {5}^{2} + 6 g 9 g 3 g 5 - 6 g 2 g 3 g 5 + g {3}^{3}$$

coeff(cube, v, 4) is as expressed by the following expression.

$$3 g {8}^{2} g 6 - 6 g 8 g 0 g 7 + 3 g 1 g {0}^{2} + 3 g {9}^{2} g 8 - 3 g {8}^{2} g 4 - 3 g {2}^{2} g 8 - 3 g {0}^{2} g 6 + 3 g 0 g {7}^{2} - 3 g 0 g {4}^{2} - 3 g 3 g {7}^{2} + 3 g {6}^{2} g 3 - 6 g 2 g 0 g 9 - 6 g 9 g 1 g 8 + 6 g 8 g 4 g 7 - 6 g 8 g 5 g 6 + 6 g 5 g 7 g 6 + 6 g 0 g 3 g 9 - 6 g 5 g 4 g 7 + 6 g 2 g 3 g 8 - 6 g 1 g 0 g 3 + 6 g 8 g 1 g 5 + 6 g 2 g 0 g 5 + 6 g 0 g 4 g 6 - 6 g 1 g 4 g 2 + 6 g 9 g 1 g 7 - 6 g 9 g 7 g 6 + 6 g 2 g 4 g 9 - 6 g 3 g 4 g 6 + 3 g {2}^{2} g 7 - 3 g 2 g {6}^{2} - 3 g {9}^{2} g 5 - 3 g {1}^{2} g 7 + 3 g 9 g {5}^{2} - 3 g 9 g {3}^{2} + 3 g {3}^{2} g 5 - 3 g 1 g {5}^{2} + 6 g 2 g 1 g 6 + g 1 g 4 g 3 - 6 g 2 g 3 g 5 + g {4}^{3}$$

coeff(cube, v, 8) is as expressed by the following expression.

$$- 6 g 8 g 0 g 7 + 6 g 2 g 0 g 8 + 3 g {0}^{2} g 9 + 3 g {8}^{2} g 1 - 3 g {8}^{2} g 4 - 3 g {2}^{2} g 8 + 3 g 0 g {6}^{2} - 3 g {0}^{2} g 6 + 3 g {7}^{2} g 4 - 3 g 0 g {4}^{2} - 3 g 3 g {7}^{2} + 3 g {9}^{2} g 7 - 6 g 2 g 0 g 9 + 6 g 8 g 7 g 6 + 6 g 9 g 8 g 5 - 6 g 9 g 1 g 8 + 6 g 1 g 4 g 0 - 6 g 8 g 5 g 6 - 6 g 5 g 4 g 7 - 6 g 1 g 0 g 3 + 6 g 9 g 2 g 6 - 6 g 1 g 4 g 2 - 6 g 9 g 7 g 6 - 6 g 3 g 4 g 6 + 6 g 0 g 3 g 5 + 6 g 9 g 4 g 3 + 3 g {4}^{2} g 6 - 3 g 2 g {6}^{2} - 3 g {9}^{2} g 5 + 3 g {1}^{2} g 2 + 3 g 8 g {3}^{2} - 3 g {1}^{2} g 7 - 3 g 9 g {3}^{2} - 3 g 1 g {5}^{2} + 6 g 1 g 7 g 5 + 6 g 2 g 3 g 7 + 6 g 2 g 4 g 5 - 6 g 2 g 3 g 5 + 6 g 1 g 3 g 6 + g {5}^{3}$$

coeff(cube, v, 5) is as expressed by the following expression.

$$3 g {0}^{2} g 8 - 6 g 8 g 0 g 7 + 6 g 9 g 7 g 8 + 3 g {8}^{2} g 5 - 3 g {8}^{2} g 5 - 3 g {8}^{2} g 4 - 3 g {2}^{2} g 8 - 3 g {0}^{2} g 6 + 3 g {1}^{2} g 0 - 3 g 0 g {4}^{2} + 3 g {9}^{2} g 2 - 3 g 3 g {7}^{2} + 6 g 2 g 8 g 6 - 6 g 2 g 0 g 9 - 6 g 9 g 1 g 8 - 6 g 8 g 5 g 6 + 6 g 8 g 4 g 3 + 6 g 9 g 0 g 6 - 6 g 5 g 4 g 7 + 6 g 0 g 3 g 7 - 6 g 1 g 0 g 3 - 6 g 1 g 4 g 2 - 6 g 9 g 7 g 6 + 6 g 0 g 4 g 5 + 6 g 5 g 3 g 6 - 6 g 3 g 4 g 6 + 6 g 2 g 4 g 7 - 3 g 2 g {6}^{2} - 3 g {9}^{2} g 5 + 3 g {5}^{2} g 7 + 3 g 9 g {4}^{2} + 3 g 1 g {7}^{2} + 3 g {2}^{2} g 3 - 3 g {1}^{2} g 7 - 3 g 9 g {3}^{2} - 3 g 1 g {5}^{2} + 6 g 1 g 3 g 9 + 6 g 2 g 1 g 5 + 6 g 1 g 4 g 6 - 6 g 2 g 3 g 5 + g {6}^{3}$$

coeff(cube, v, 10) is as expressed by the following expression.

$$3 g 2 g {8}^{2} + 6 g 9 g 0 g 8 - 6 g 8 g 0 g 7 - 3 g {8}^{2} g 4 + 3 g 8 g {6}^{2} + 3 g {0}^{2} g 3 - 3 g {2}^{2} g 8 - 3 g {0}^{2} g 6 + 3 g {9}^{2} g 6 - 3 g 0 g {4}^{2} - 3 g 3 g {7}^{2} - 6 g 2 g 0 g 9 + 6 g 2 g 4 g 0 - 6 g 9 g 1 g 8 - 6 g 8 g 5 g 6 + 6 g 7 g 4 g 6 + 6 g 1 g 0 g 7 - 6 g 5 g 4 g 7 - 6 g 1 g 0 g 3 + 6 g 1 g 4 g 8 - 6 g 1 g 4 g 2 - 6 g 9 g 7 g 6 + 6 g 8 g 3 g 5 - 6 g 3 g 4 g 6 + 6 g 2 g 7 g 5 + 6 g 9 g 3 g 7 + 3 g {2}^{2} g 1 - 3 g 2 g {6}^{2} - 3 g {9}^{2} g 5 + 3 g 0 g {5}^{2} + 3 g {1}^{2} g 9 + 3 g {3}^{2} g 4 - 3 g {1}^{2} g 7 - 3 g 9 g {3}^{2} - 3 g 1 g {5}^{2} + 6 g 1 g 5 g 6 + 6 g 9 g 4 g 5 + 6 g 2 g 3 g 6 - 6 g 2 g 3 g 5 + g {7}^{3}$$

coeff(cube, v, 9) is as expressed by the following expression.

$$6 g 1 g 3 g 5 + g {8}^{3} - 6 g 8 g 0 g 7 + 6 g 0 g 4 g 8 + 3 g {0}^{2} g 7 - 3 g {8}^{2} g 4 - 3 g {2}^{2} g 8 + 3 g {2}^{2} g 0 - 3 g {0}^{2} g 6 - 3 g 0 g {4}^{2} - 3 g 3 g {7}^{2} - 6 g 2 g 0 g 9 - 6 g 9 g 1 g 8 + 6 g 2 g 1 g 8 + 6 g 1 g 0 g 9 + 6 g 8 g 7 g 5 - 6 g 8 g 5 g 6 + 6 g 0 g 5 g 6 - 6 g 5 g 4 g 7 - 6 g 1 g 0 g 3 + 6 g 3 g 4 g 7 - 6 g 1 g 4 g 2 + 6 g 9 g 2 g 5 - 6 g 9 g 7 g 6 + 6 g 8 g 3 g 6 + 6 g 2 g 7 g 6 - 6 g 3 g 4 g 6 - 3 g 2 g {6}^{2} - 3 g {9}^{2} g 5 + 3 g 9 g {7}^{2} + 3 g {4}^{2} g 5 + 3 g 1 g {6}^{2} + 3 g {1}^{2} g 4 + 3 g {9}^{2} g 3 - 3 g {1}^{2} g 7 - 3 g 9 g {3}^{2} - 3 g 1 g {5}^{2} + 3 g 2 g {3}^{2} + 6 g 9 g 4 g 6 - 6 g 2 g 3 g 5$$

coeff(cube, v, 7) is as expressed by the following expression.

$$3 g 1 g {3}^{2} + 3 g {8}^{2} g 0 - 6 g 8 g 0 g 7 + 6 g 1 g 0 g 2 + 6 g 9 g 8 g 6 + 3 g {0}^{2} g 4 - 3 g {8}^{2} g 4 - 3 g {2}^{2} g 8 - 3 g {0}^{2} g 6 - 3 g 0 g {4}^{2} - 3 g 3 g {7}^{2} - 6 g 2 g 0 g 9 - 6 g 9 g 1 g 8 - 6 g 8 g 5 g 6 + 6 g 8 g 3 g 7 + 6 g 0 g 7 g 5 - 6 g 5 g 4 g 7 - 6 g 1 g 0 g 3 - 6 g 1 g 4 g 2 - 6 g 9 g 7 g 6 + 6 g 8 g 4 g 5 + 6 g 0 g 3 g 6 + 6 g 9 g 4 g 7 - 6 g 3 g 4 g 6 + 6 g 1 g 7 g 6 + 6 g 2 g 3 g 9 + 3 g {1}^{2} g 8 - 3 g 2 g {6}^{2} + 3 g 3 g {4}^{2} - 3 g {9}^{2} g 5 + 3 g {5}^{2} g 6 + 3 g 2 g {7}^{2} + 3 g {2}^{2} g 5 - 3 g {1}^{2} g 7 - 3 g 9 g {3}^{2} - 3 g 1 g {5}^{2} + 6 g 9 g 1 g 5 + 6 g 2 g 4 g 6 - 6 g 2 g 3 g 5 + g {9}^{3}$$

coeff(cube, v, 3) is as expressed by the following expression.

$$3 g {1}^{2} g 5 + g {0}^{3} - 6 g 8 g 0 g 7 + 6 g 2 g 7 g 8 + 6 g 8 g 0 g 5 + 3 g {6}^{2} g 7 - 3 g {8}^{2} g 4 - 3 g {2}^{2} g 8 + 3 g {8}^{2} g 3 - 3 g {0}^{2} g 6 - 3 g 0 g {4}^{2} + 3 g {2}^{2} g 9 - 3 g 3 g {7}^{2} - 6 g 2 g 0 g 9 + 6 g 9 g 0 g 7 - 6 g 9 g 1 g 8 + 6 g 9 g 4 g 8 - 6 g 8 g 5 g 6 + 6 g 8 g 1 g 6 - 6 g 5 g 4 g 7 + 6 g 2 g 0 g 6 + 6 g 0 g 4 g 3 - 6 g 1 g 0 g 3 + 6 g 3 g 7 g 5 - 6 g 1 g 4 g 2 - 6 g 9 g 7 g 6 + 6 g 9 g 5 g 6 - 6 g 3 g 4 g 6 + 6 g 2 g 1 g 3 - 3 g 2 g {6}^{2} - 3 g {9}^{2} g 5 + 3 g {9}^{2} g 1 + 3 g 2 g {4}^{2} - 3 g {1}^{2} g 7 + 3 g {5}^{2} g 4 + 3 g {3}^{2} g 6 - 3 g 9 g {3}^{2} - 3 g 1 g {5}^{2} + 6 g 1 g 4 g 7 - 6 g 2 g 3 g 5$$

coeff(cube, v, 6) is as expressed by the following expression.

$$3 g 2 g {0}^{2} - 6 g 8 g 0 g 7 + 6 g 1 g 0 g 8 - 3 g {8}^{2} g 4 - 3 g {2}^{2} g 8 + 3 g 8 g {7}^{2} - 3 g {0}^{2} g 6 + 3 g 5 g {6}^{2} + 3 g {4}^{2} g 7 - 3 g 0 g {4}^{2} - 3 g 3 g {7}^{2} - 6 g 2 g 0 g 9 - 6 g 9 g 1 g 8 + 6 g 2 g 8 g 5 + 6 g 0 g 7 g 6 - 6 g 8 g 5 g 6 + 6 g 2 g 7 g 9 + 6 g 9 g 3 g 8 - 6 g 5 g 4 g 7 - 6 g 1 g 0 g 3 + 6 g 9 g 0 g 5 + 6 g 8 g 4 g 6 - 6 g 1 g 4 g 2 - 6 g 9 g 7 g 6 - 6 g 3 g 4 g 6 + 6 g 9 g 1 g 6 - 3 g 2 g {6}^{2} - 3 g {9}^{2} g 5 + 3 g {2}^{2} g 6 + 3 g 0 g {3}^{2} + 3 g {9}^{2} g 4 - 3 g {1}^{2} g 7 + 3 g {5}^{2} g 3 - 3 g 9 g {3}^{2} - 3 g 1 g {5}^{2} + 6 g 2 g 4 g 3 + 6 g 1 g 3 g 7 - 6 g 2 g 3 g 5 + 6 g 1 g 4 g 5 + g {1}^{3}$$

Here, zero of Expression (68) is calculated from the ten sets of conditional expressions.

$$zero = coeff ( left , v , 1 ) + coeff ( left , v , 2 ) + ( coeff ( left , v , 4 ) + coeff ( left , v , 8 ) + coeff ( left , v , 5 ) + coeff ( left , v , 10 ) + coeff ( left , v , 9 ) + coeff ( left , v , 7 ) + coeff ( left , v , 3 ) + coeff ( left , v , 6 ) - ( coeff ( right , v , 1 ) + coeff ( right , v , 2 ) + coeff ( right , v , 4 ) + coeff ( right , v , 8 ) + coeff ( right , v , 5 ) + coeff ( right , v , 10 ) + coeff ( right , v , 9 ) + coeff ( right , v , 7 ) + coeff ( right , v , 3 ) + coeff ( right , v , 6 ) )$$

This zero of Expression (68) is developed as follows.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 5 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 + 3 g {8}^{2} g 4 - 8 g 8 g {6}^{2} + 3 g {7}^{2} g 6 + 3 g {0}^{2} g 3 + 3 g {2}^{2} g 8 + 3 g {2}^{2} g 0 - 8 g {8}^{2} g 3 - 8 g 8 g {7}^{2} + 3 g 0 g {6}^{2} + 3 g {0}^{2} g 6 + 3 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 - 3 g 0 g {4}^{2} + 3 g {2}^{2} g 9 + 3 g 3 g {7}^{2} + 3 g {6}^{2} g 3 + 3 g 9 g {6}^{2} + g 3 g {9}^{2} g 7 - 5 g 2 g 8 g 6 - 5 g 2 g 0 g 9 - 5 g 2 g 4 g 0 - 5 g 9 g 1 g 8 + 6 g 8 g 1 g 7 + 6 g 8 g 7 g 6 - 5 g 9 g 8 g 5 + 6 g 9 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 9 g 4 g 8 - 5 g 8 g 4 g 7 - 5 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 5 g 5 g 4 g 7 - 5 g 3 g 7 g 6 - 5 g 2 g 0 g 6 - 5 g 2 g 3 g 8 - 5 g 1 g 0 g 3 - 5 g 1 g 4 g 8 - 5 g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 5 g 1 g 4 g 2 - 5 g 9 g 1 g 7 - 5 g 9 g 2 g 5 - 5 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 - 5 g 0 g 4 g 5 + 6 g 8 g 3 g 5 + 6 g 5 g 3 g 6 - 5 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 2 g {6}^{2} + 3 g 3 g {4}^{2} + 3 g 8 g {5}^{2} + 3 g {9}^{2} g 5 - 8 g 9 g {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {1}^{2} g 7 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 + 3 g 9 g {3}^{2} - 8 g {1}^{2} g 6 - 8 g {3}^{2} g 5 + 3 g 1 g {5}^{2} + 3 g 2 g {3}^{2} + 6 g 3 g 4 g 5 + 6 g 2 g 1 g 6 + 6 g 2 g 3 g 7 + 6 g 2 g 4 g 3 - 5 g 1 g 3 g 9 - 5 g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 5 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + g {1}^{3} + g {2}^{3} + g {4}^{3} + g {9}^{3} + g {7}^{3}$$

The zero of Expression (68) is added to each of the coefficients of Expression (67) that is a common arithmetic expression for cubing. As a result, the arithmetic expression of the cube g³ of an element of the tenth degree extension field F_{q̂10} is expressed as in the following Expression (69).

$${v}^{3} = ( coeff ( cube , v , 1 ) + zero ) \times v + ( coeff ( cube , v , 2 ) + zero ) \times {v}^{2} + ( coeff ( cube , v , 4 ) + zero ) \times {v}^{4} + ( coeff ( cube , v , 8 ) + zero ) \times {v}^{8} + ( coeff ( cube , v , 5 ) + zero ) \times {v}^{5} + ( coeff ( cube , v , 10 ) + zero ) \times {v}^{10} + ( coeff ( cube , v , 9 ) + zero ) \times {v}^{9} + ( coeff ( cube , v , 7 ) + zero ) \times {v}^{7} + ( coeff ( cube , v , 3 ) + zero ) \times {v}^{3} + ( coeff ( cube , v , 6 ) + zero ) \times {v}^{6} \qquad ( 69 )$$

coeff(cube, v, 1)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 12 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 6 g {7}^{2} g 6 + 3 g {0}^{2} g 3 + 3 g {2}^{2} g 0 - 8 g {8}^{2} g 3 - 8 g 8 g {7}^{2} + 3 g 0 g {6}^{2} + 3 g {5}^{2} g 6 + 3 g {7}^{2} g 4 + 3 g 8 g {4}^{2} - 8 g {9}^{2} g 0 + 3 g 0 g {7}^{2} + 3 g {9}^{2} g 6 - 5 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 3 g {6}^{2} g 3 + 3 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 12 g 8 g 1 g 7 + 6 g 8 g 7 g 6 - 5 g 9 g 8 g 5 + 6 g 9 g 0 g 7 - 5 g 2 g 8 g 5 + 12 g 2 g 0 g 7 - 5 g 2 g 1 g 8 + 12 g 0 g 4 g 9 + 6 g 0 g 7 g 6 + 6 g 1 g 0 g 9 + 6 g 1 g 4 g 0 - 5 g 9 g 4 g 8 - 5 g 8 g 4 g 7 - 11 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 + g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 - 5 g 1 g 4 g 8 - 5 g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 12 g 2 g 1 g 9 + g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 + g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 + g 2 g 5 g 6 + 6 g 2 g 7 g 5 - 6 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 3 g {4}^{2} + 6 g 8 g {5}^{2} - 8 g 9 g {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 3 g {1}^{2} g 9 + 3 g {2}^{2} g 5 + 6 g {3}^{2} g 7 + 6 g 1 g {4}^{2} - 8 g {3}^{2} g 4 + 3 g {9}^{2} g 3 + 3 g {5}^{2} g 4 + 3 g 9 g {5}^{2} - 5 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 12 g 3 g 4 g 5 + 6 g 2 g 1 g 6 + 6 g 2 g 3 g 7 + 6 g 2 g 4 g 3 - 5 g 1 g 3 g 9 - 5 g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + g {1}^{3} + 2 g {2}^{3} + g {4}^{3} + g {9}^{3} + g {7}^{3}$$

coeff(cube, v, 2)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 12 g 9 g 2 g 8 - 5 g 0 g 4 g 8 + 6 g 1 g 0 g 8 + 6 g 9 g 7 g 8 - g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 3 g {7}^{2} g 6 + 3 g {0}^{2} g 3 + 3 g {2}^{2} g 0 - 8 g {8}^{2} g 3 - 8 g 8 g {7}^{2} + 3 g 0 g {6}^{2} + 3 g 5 g {6}^{2} + 3 g {7}^{2} g 4 + 6 g 8 g {4}^{2} - 5 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 6 g 5 g {7}^{2} + 3 g {6}^{2} g 4 + 3 g {9}^{2} g 2 + 3 g {2}^{2} g 9 + 3 g {6}^{2} g 3 + 6 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 6 g 8 g 1 g 7 + 6 g 8 g 7 g 6 - 5 g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 9 g 4 g 8 - 5 g 8 g 4 g 7 - 11 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 12 g 2 g 0 g 3 - 5 g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 + g 0 g 4 g 7 - 11 g 5 g 4 g 7 + g 3 g 7 g 6 - 5 g 2 g 0 g 6 - 5 g 2 g 3 g 8 - 11 g 1 g 0 g 3 - 5 g 1 g 4 g 8 - 5 g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 12 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 12 g 5 g 4 g 6 + g 2 g 1 g 7 + 6 g 2 g 4 g 9 - 5 g 2 g 7 g 6 + 12 g 1 g 0 g 5 + 6 g 9 g 4 g 7 + 6 g 9 g 5 g 6 + 5 g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 12 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 3 g {4}^{2} + 3 g 8 g {5}^{2} - 8 g 9 g {7}^{2} - 8 g {1}^{2} g 2 - 8 g {4}^{2} g 5 - 8 g {5}^{2} g 6 - 8 g 1 g {6}^{2} - 5 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 6 g 2 g {5}^{2} + 3 g {5}^{2} g 3 - 5 g {1}^{1} g 6 - 8 g {3}^{2} g 5 + 3 g 2 g {3}^{2} + 6 g 3 g 4 g 5 + 6 g 2 g 1 g 6 + 6 g 2 g 3 g 7 + 6 g 2 g 4 g 3 - 5 g 1 g 3 g 9 - 4 g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} + g {6}^{3} + 2 g {3}^{3} + g {5}^{3} + g {1}^{3} + g {2}^{3} + g {4}^{3} + g {9}^{3} + g {7}^{3}$$

coeff(cube, v, 4)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 3 g {7}^{2} g 6 + 3 g {0}^{3} g 3 + 3 g {2}^{2} g 0 - 8 g {8}^{2} g 3 - 8 g 8 g {7}^{2} + 3 g 0 g {6}^{2} + 3 g 5 g {6}^{2} + 3 g {7}^{2} g 4 + 3 g 8 g {4}^{2} - 8 g {9}^{2} g 0 + 6 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 6 g {6}^{2} g 3 + 3 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 6 g 8 g 1 g 7 + 6 g 8 g 7 g 6 - 5 g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 9 g 4 g 8 + g 8 g 4 g 7 - 11 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 12 g 5 g 7 g 6 + 6 g 2 g 0 g 3 - 5 g 2 g 4 g 8 - 6 g 2 g 7 g 9 + 6 g 0 g 5 g 6 + 6 g 0 g 7 g 5 - 5 g 1 g 0 g 7 + 6 g 9 g 3 g 8 + 12 g 0 g 3 g 9 - 5 g 0 g 4 g 7 - 11 g 5 g 4 g 7 - 5 g 3 g 7 g 6 - 5 g 2 g 0 g 6 + g 2 g 3 g 8 - 11 g 1 g 0 g 3 - 5 g 1 g 4 g 8 - 5 g 9 g 2 g 6 - 5 g 0 g 3 g 7 - 5 g 0 g 4 g 3 + g 8 g 1 g 5 - 5 g 8 g 4 g 6 - 5 g 9 g 0 g 5 + 6 g 3 g 4 g 7 - 5 g 3 g 7 g 5 + 12 g 2 g 0 g 5 + 6 g 2 g 1 g 9 - 5 g 1 g 0 g 6 + 6 g 1 g 3 g 8 - 11 g 1 g 4 g 2 + g 9 g 1 g 7 - 5 g 9 g 2 g 5 - 11 g 9 g 7 g 6 + g 0 g 4 g 6 + 6 g 8 g 3 g 6 + 6 g 8 g 4 g 5 + 6 g 5 g 4 g 6 - 5 g 2 g 1 g 7 + 12 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 - 5 g 0 g 4 g 5 - 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 5 g {2}^{2} g 7 - 8 g {4}^{2} g 6 + 3 g {2}^{2} g 1 + 3 g 3 g {4}^{2} + 3 g 8 g {5}^{2} - 8 g 9 g {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 6 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 5 g {3}^{2} g 5 + 3 g 2 g {3}^{2} + 6 g 3 g 4 g 5 + 12 g 2 g 1 g 6 + 6 g 2 g 3 g 7 + 6 g 2 g 4 g 3 - 5 g 1 g 3 g 9 - 5 g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 12 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {5}^{3} + g {1}^{3} + g {2}^{3} + 2 g {4}^{3} + g {9}^{3} + g {7}^{3}$$

coeff(cube, v, 8)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 6 g {8}^{2} g 6 - 8 g 2 g {0}^{2} - 11 g 8 g 0 g 7 + 6 g 9 g 0 g 8 + g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 3 g {7}^{2} g 6 + 3 g {0}^{2} g 3 + 3 g {2}^{2} g 0 - 8 g {8}^{2} g 3 - 8 g 8 g {7}^{2} + 6 g 0 g {6}^{2} + 3 g 5 g {6}^{2} + 6 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 3 g {6}^{2} g 3 + 3 g 9 g {6}^{2} + 6 g {9}^{2} g 7 - 5 g 2 g 8 g 6 - 11 g 2 g 0 g 9 - 5 g 2 g 4 g 0 - 11 g 9 g 1 g 8 + 6 g 8 g 1 g 7 + 12 g 8 g 7 g 6 + g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 12 g 1 g 4 g 0 - 5 g 9 g 4 g 8 - 5 g 8 g 4 g 7 - 11 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 - 5 g 1 g 4 g 8 + g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 + g 9 g 4 g 3 + 12 g 0 g 3 g 5 + 3 g {1}^{2} g 8 - 8 g {2}^{2} g 7 - 5 g {4}^{2} g 6 + 3 g {2}^{2} g 1 + 3 g 3 g {4}^{2} + 3 g 8 g {5}^{2} - 8 g 9 g {7}^{2} - 5 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 5 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 2 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 12 g 2 g 3 g 7 + 6 g 2 g 4 g 3 - 5 g 1 g 3 g 9 - 5 g 1 g 4 g 7 - 5 g 1 g 5 g 6 + g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 12 g 2 g 4 g 5 + 6 g 1 g 4 g 6 - 5 g 9 g 3 g 5 - 11 g 2 g 3 g 5 + 12 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + 2 g {5}^{3} + g {1}^{3} + g {2}^{3} + g {4}^{3} + g {9}^{3} g {7}^{3}$$

coeff(cube, v, 5)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 6 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 12 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 + 3 g 8 g {6}^{2} + 3 g {7}^{2} g 6 + 3 g {0}^{2} g 3 + 3 g {2}^{2} g 0 + 3 g {2}^{2} g 0 - 8 g {8}^{2} g 3 - 8 g 8 g {7}^{2} + 3 g 0 g {6}^{2} + 3 g {0}^{2} g 6 + 3 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 6 g {1}^{2} g 0 + 3 g {4}^{2} g 7 + 3 g 5 g {7}^{2} + 3 g {6}^{2} g 4 + 6 g {9}^{2} g 2 + 3 {g}^{2} g 9 + 3 g {6}^{2} g 3 + 3 g 9 g {6}^{2} + 3 g {9}^{2} g 7 + g 2 g 8 g 6 - 11 g 2 g 0 g 9 - 5 g 2 g 4 g 0 - 11 g 9 g 1 g 8 + 6 g 8 g 1 g 7 + 6 g 8 g 7 g 6 + 5 g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 9 g 4 g 8 - 5 g 8 g 4 g 7 - 11 g g 5 g 6 + 6 g 8 g 7 g 5 + 6 g 7 g 4 g 6 + 6 g 8 g 1 g 6 - 5 g 8 g 3 g 7 + 12 g 8 g 4 g 3 + g 9 g 0 g 6 + 6 g 5 g 7 g 6 + 6 g 2 g 0 g 3 + 5 g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 - 5 g 1 g 4 g 8 - 5 g 9 g 2 g 6 + g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 + g 0 g 4 g 5 + 6 g 8 g 3 g 5 + 12 g 5 g 3 g 6 - 11 g 3 \; 4 g 6 + 6 g 2 g 1 g 3 - 5 g 2 g 3 g 9 + 12 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 - 5 g 9 g 4 g 3 + 6 g 0 g3 g 5 + 3 g {1}^{2} g 8 - 8 g {2}^{2} g 7 - 8 g {4}^{2} g 6 + 3 g {2}^{2} g 1 + 3 g 3 g {4}^{2} + 3 g 8 g {5}^{2} - 8 g 9 {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 5 g {5}^{2} g 7 - 8 g 8 g {3}^{2} - 8 g {9}^{2} g 1 - 5 g 9 g {4}^{2} - 8 g 0 g {5}^{2} + 3 g {1}^{2} g 4 + 3 g {2}^{2} g 6 + 6 g 1 g {7}^{2} - 5 g {2}^{2} g 3 + 3 g 2 g {4}^{2} - 8 g {9}^{2} g 4 + 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 6 g 2 g 3 g 7 + 6 g 2 g 4 g 3 + g 1 g 3 g 9 - 5 g 1 g 4 g 7 - 5 g 1 g 5 g 6 - 5 g 1 g 7 g 5 - 5 g 9 g 1 g 5 + 6 g 9 g 4 g 6 + 12 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 12 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + 2 g {6}^{3} + g {3}^{3} + g {5}^{3} + g {1}^{3} + g {2}^{3} + g {4}^{3} + g {9}^{3} + g {7}^{3}$$

coeff(cube, v, 10)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 12 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 3 g {7}^{2} g 6 + 3 g {0}^{2} g 3 + 3 g {2}^{2} g 0 - 8 g {8}^{2} g 3 - 8 g 8 g {7}^{2} + 3 g 0 g {6}^{2} + 3 g 5 g {6}^{2} + 3 g {7}^{2} g 4 + 3 g 8 g {4}^{2} - 8 g {9}^{2} g 0 + 3 g 0 g {7}^{2} + 6 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 3 g {6}^{2} g 3 + 3 g 9 g {6}^{2} - 3 g {9}^{2} g 7 - 5 g 2 g 8 g 6 - 11 g 2 g 0 g 9 + g 2 g 4 g 0 - 11 g 9 g 1 g 8 + 6 g 8 g 1 g 7 + 6 g 8 g 7 g 6 - 5 g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 9 g 4 g 8 - 5 g 8 g 4 g 7 - 11 g 8 g 5 g 6 + 6 g 8 g 7 g 5 + 12 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 6 g 0 g 5 g 6 + 6 g 0 g 7 g 5 + g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 + g 1 g 4 g 8 - 5 g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 - 5 g 0 g 4 g 5 + 12 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 12 g 2 g 7 g 5 + 6 g 1 g 4 g 9 + 6 g 1 g 7 g 6 + 6 g 9 g 1 g 6 + g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 6 g {2}^{2} g 1 + 3 g 3 g {4}^{2} + 3 g 8 g {5}^{2} - 8 g 9 g {7}^{2} 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 5 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 - 3 g 0 g {3}^{2} + 6 g {1}^{2} g 9 + 3 g {2}^{2} g 5 + 3 g {3}^{2} g 7 + 3 g 1 g {4}^{2} - 5 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 6 g 2 g 3 g 7 + 6 g 2 g 4 g 3 - 5 g 1 g 3 g 9 - 5 g 1 g 4 g 7 + g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 12 g 9 g 4 g 5 + 12 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + g {1}^{3} + g {2}^{3} + g {4}^{3} + g {9}^{3} + 2 g {7}^{3}$$

coeff(cube, v, 9)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 + 5 g 2 g 0 g 8 + 6 g 9 g 2 g 8 + g 0 g 4 g 8 + 6 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 6 g {0}^{2} g 7 - 8 g {6}^{2} g 7 - 8 g 8 g {6}^{2} + 3 g {7}^{2} g 6 + 3 g {0}^{2} g 3 + 6 g {2}^{2} g 0 - 8 g {8}^{2} g 3 - 8 g 8 g {7}^{2} + 3 g 0 g {6}^{2} + 3 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 3 g {6}^{2} g 3 + 3 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 6 g 8 \; 1 g 7 + 6 g 8 g 7 g 6 - 5 g 9 g 8 g 5 + 6 g 9 g 0 g 7 - 5 g 2 g 8 g 5 + 6 g 2 g 0 g 7 + g 2 g 1 g 8 + 6 g 0 g 4 g 9 + 6 g 0 g 7 g 6 + 12 g 1 g 0 g 9 + 6 g 1 g 4 g 0 - 5 g 9 g 4 g 8 - 5 g 8 g 4 g 7 - 11 g 8 g 5 g 6 + 12 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 12 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 - 5 g 1 g 4 g 8 - 5 g 9 g 2 g 6 - 5 g 0 g 3 g 7 - 5 g 0 g 4 g 3 - 5 g 8 g 1 g 5 - 5 g 8 g 4 g 6 - 5 g 9 g 0 g 5 + 12 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 + g 9 g 2 g 5 - 11 g 9 g 7 g 6 - 5 g 0 g 4 g 6 + 12 g 8 g 3 g 6 + 6 g 8 g 4 g 5 + 6 g 5 g 4 g 6 - 5 g 2 g 1 g 7 + 6 g 2 g 4 g 9 + g 2 g 7 g 6 + 6 g 1 g 0 g 5 + 6 g 9 g 4 g 7 + 6 g9 g 5 g 6 - 5 g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 3 g {4}^{2} + 3 g 8 g {5}^{2} - 5 g 9 g {7}^{2} - 8 g {1}^{2} g 2 - 5 g {4}^{2} g 5 - 8 g {5}^{2} g 6 - 5 g 1 g {6}^{2} - 8 g {2}^{2} g 4 - 8 g 2 g {7}^{2} - 8 g {5}^{2} g 7 - 8 g {5}^{2} g 7 - 8 g 8 g {3}^{2} - 8 g {9}^{2} g 1 - 8 g 9 g {4}^{2} - 8 g 0 g {5}^{2} + 6 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 - 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 6 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 6 g 2 g {3}^{2} + 6 g 3 g 4 g 5 + 6 g 2 g 1 g 6 + 6 g 2 g 3 g 7 + 6 g 2 g 4 g 3 - 5 g 1 \; 3 g 9 - 5 g 1 g 4 g 7 - 6 g 1 g 5 g 6 - 5 g 1 g 7 g 5 - 5 g 9 g 1 g 5 + 12 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + g {1}^{3} + g {2}^{3} + g {4}^{3} + g {9}^{3} + g {7}^{3}$$

coeff(cube, v, 7)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 5 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 6 g 2 g 7 g 8 + 12 g 1 g 0 g 2 + 6 g 0 g 3 g 8 + 6 g 8 g 0 g 5 + 12 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 6 g {0}^{2} g 4 + 3 g {0}^{2} g 7 - 8 g {6}^{2} g 7 - 8 g 8 g {6}^{2} + 3 g {7}^{2} g 6 + 3 g {0}^{2} g 3 + 3 g {2}^{2} g 0 - 8 g {8}^{2} g 3 - 8 g 8 g {7}^{2} + 3 g 0 g {6}^{2} + 3 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 3 g {2}^{2} g 9 + 3 g {6}^{2} g 3 + 3 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 6 g 8 g 1 g 7 + 6 g 8 g 7 g 6 - 5 g 9 g 8 g 5 + 6 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 - 5 g 8 g 4 g 7 - 11 g 8 g 5 g 6 + 6 g 8 g 7 g 5 + 6 g 7 \; 8 \; 4 g 6 + 6 g 8 g 1 g 6 + g 1 g 6 + g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 6 g 0 g 5 g 6 + 12 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 - 5 g 2 g 0 g 6 - 5 g 2 g 3 g 8 - 11 g 1 g 0 g 3 - 5 g 1 g 4 g 8 - 5 g 9 g 2 g 6 - 5 g 0 g 2 g 7 - 5 g 0 g 4 g 3 - 5 g 8 g 1 g 5 - 5 g 8 g 4 g 6 - 5 g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 12 g 8 g 4 g 5 + 66 g 5 g 4 g 6 - 5 g 2 g 1 g 7 + 6 g 2 g 4 g 9 - 5 g 2 g 7 g 6 + 6 g 1 g 0 g 5 + 12 g 9 g 4 g 7 + 6 g 9 g 5 g 6 - 5 g 9 g 7 g 5 + g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 + g 2 g 3 g 9 + 6 g 2 g 4 g 7 - 5 g 2 g 5 g 6 + 6 g 2 g 7 g 5 + 6 g 1 g 4 g 9 + 12 g 1 g 7 g 6 + 6 g 9 g 1 g 6 - 5 g 9 g 3 g 7 - 5 g 9 g 4 g 3 + 6 g 0 g 3 g 5 + 6 g {1}^{2} g 8 - 8 g {2}^{2} g 7 - 8 g {4}^{2} g 6 + 3 g {2}^{2} g 1 + 6 g 3 g {4}^{2} + 3 g 8 g {5}^{2} - 8 g 9 g {7}^{2} - 8 g 1 g 2 - 8 g {4}^{2} g 5 - 5 g {5}^{2} g 6 - 8 g 1 g {6}^{2} - 8 g {2}^{2} g 4 - 5 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 3 g 2 g {4}^{2} - 8 g {9}^{2} g 4 + 3 g 0 g {3}^{2} + 3 g {1}^{2} g 9 + 6 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 6 g 2 g 3 g 7 + 6 g 2 g 4 g 3 - 5 g 1 g 3 g 9 - 5 g 1 g 4 g 7 - 5 g 1 g 5 g 6 - 5 g 1 g 7 g 5 + g 9 g 1 g 5 + 6 g 9 g 4 g 6 + 6 g 2 g 1 g 5 + g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {5}^{3} + g {1}^{3} + g {2}^{3} + g {4}^{3} + 2 g {9}^{3} + g {7}^{3}$$

coeff(cube, v, 3)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + 2 g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 8 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 6 g 1 g 0 g 8 + 6 g 9 g 7 g 8 - 5 g 8 g 0 g 6 + 12 g 2 g 7 g 8 + 6 g 1 g 0 g 2 + 6 g 0 g 3 g 8 + 12 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 5 g {6}^{2} g 7 - 8 g 8 g {6}^{2} + 3 g {7}^{2} g 6 + 3 g {0}^{2} g 3 + 3 g {2}^{2} g 0 - 5 g {8}^{2} g 3 - 8 g 8 g {7}^{2} + 3 g 0 g {6}^{2} + 3 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 6 g {2}^{2} g 9 + 3 g {6}^{2} g 3 + 3 g 9 g {6}^{2} + 3 g 9 g {6}^{2} + 3 {g9}^{2} g 7 - 5 g 2 g 8 g 6 - 11 g 2 g 0 g 9 - 5 g 2 g 4 g 0 - 11 g 9 g 1 g 8 + 6 g 8 g 7 g 6 - 5 g 9 g 8 g 5 + 12 g 9 g 0 g 7 - 5 g 2 g 8 g 5 + 6 g 2 g 0 g 7 - 5 g 2 g 1 g 8 + 6 g 0 g 4 g 9 + 6 g 0 g 7 g 6 + 6 g 1 g 0 g 9 + 6 g 1 g 4 g 0 + g 9 g 4 g 8 - 5 g 8 g 4 g 7 - 11 g 8 g 5 g 6 + 6 g 8 g 7 g 5 + 6 g 7 g 4 g 6 + 12 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 6 g 2 g 7 g 9 + 6 g 0 g 5 g 6 + 6 g 0 g 7 g 5 - 5 g 1 g 0 g 7 + 6 g 9 g 3 g 8 + 6 g 0 g 3 g 9 - 5 g 0 g 4 g 7 - 11 g 5 g 4 g 7 - 5 g 3 g 7 g 6 + g 2 g 0 g 6 - 5 g 2 g 3 g 8 - 11 g 1 g 0 g 3 - 5 g 1 g 4 g 8 - 5 g 9 g 2 g 6 - 5 g 0 g 3 g 7 + g 0 g 4 g 3 + 5 g 8 g 1 g 5 - 5 g 8 g 4 g 6 - 5 g 9 g 0 g 5 + 6 g 3 g 4 g 7 + g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 12 g 9 g 5 g 6 - 5 g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 12 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 6 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 3 g {4}^{2} + 3 g 8 g {5}^{2} - 8 g 9 g {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 5 g {9}^{2} g 1 - 8 g 9 g {4}^{2} - 8 g 0 g {5}^{2} + 3 g {1}^{2} g 4 + 3 g {2}^{2} g 6 + 3 g 1 g {7}^{2} - 8 g {2}^{2} g 3 + 6 g 2 g {4}^{2} - 8 g {9}^{2} g 4 + 3 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 6 g {5}^{2} g 4 + 3 g 9 g {5}^{2} - 8 g 1 g 3 + 6 g {3}^{2} g 6 + 3 g 2 g {5}^{2} + 3 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 6 g 2 g 3 g 7 + 6 g 2 g 4 g 3 - 5 g 1 g 3 g 9 + g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 - 5 g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 - 5 g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + g {1}^{3} + g {2}^{3} + g {4}^{3} + g {9}^{3} + g {7}^{3}$$

coeff(cube, v, 6)+zero is as expressed by the following expression.

$$- 5 g 1 g 3 g 5 + 3 g {1}^{2} g 5 + 3 g 1 g {3}^{2} - 2 g 3 g 9 - 2 g 8 g 9 - 2 g 7 g 6 - 2 g 7 g 9 - 2 g 5 g 7 - 2 g 7 g 1 - 2 g 1 g 9 - 2 g 9 g 0 - 2 g 8 g 7 - 2 g 6 g 8 - 2 g 0 g 1 + 9 g 9 g 2 + 9 g 8 g 5 + 9 g 9 g 6 + 9 g 0 g 7 + 9 g 1 g 8 + 9 g 7 g 4 - 2 g 8 g 4 + 9 g 0 g 3 - 2 g 2 g 7 - 2 g 3 g 1 - 2 g 9 g 5 - 2 g 7 g 3 - 2 g 1 g 6 - 2 g 5 g 1 - 2 g 0 g 8 - 2 g 2 g 1 - 2 g 9 g 4 - 2 g 3 g 8 - 2 g 6 g 5 + 9 g 1 g 4 - 2 g 0 g 6 - 2 g 2 g 8 + 9 g 3 g 6 - 2 g 4 g 5 - 2 g 6 g 4 - 2 g 0 g 2 - 2 g 0 g 4 - 2 g 3 g 5 - 2 g 2 g 6 - 2 g 3 g 2 - 2 g 0 g 5 + 9 g 2 g 5 - 2 g 3 g 4 - 2 g 2 g 4 + g {0}^{3} + g {8}^{3} - 8 g {8}^{2} g 0 + 3 g {0}^{2} g 8 - 8 g 9 g {8}^{2} + 3 g 2 g {8}^{2} + 3 g {8}^{2} g 7 + 3 g {8}^{2} g 6 - 5 g 2 g {0}^{2} - 11 g 8 g 0 g 7 + 6 g 9 g 0 g 8 - 5 g 2 g 0 g 8 + 6 g 9 g 2 g 8 - 5 g 0 g 4 g 8 + 12 g 1 g 0 g 8 + 6 g 9 g 7 g 8 - 5 g 8 g 0 g 6 + 6 g 2 g 7 g 8 + 6 g 1 g 0 g 2 + 6 g 0 g 3 g 8 + 6 g 8 g 0 g 5 + 6 g 9 g 8 g 6 + 3 g {0}^{2} g 9 + 3 g {8}^{2} g 5 - 8 g 1 g {0}^{2} + 3 g {8}^{2} g 1 + 3 g {9}^{2} g 8 + 3 g {0}^{2} g 4 + 3 g {0}^{2} g 7 - 8 g {6}^{2} g 7 - 8 g 8 g {6}^{2} + 3 g {7}^{2} g 6 + 3 g {0}^{2} g 3 + 3 g {2}^{2} g 0 - 8 g {8}^{2} g 3 - 5 g 8 g {7}^{2} + 3 g 0 g {6}^{2} + 6 g 5 g {6}^{2} + 3 g {7}^{2} g 4 + 3 g 8 g {4}^{2} - 8 g {9}^{2} g 0 + 3 g 0 g {7}^{2} + 3 g {9}^{2} g 6 - 8 g {0}^{2} g 5 + 3 g {1}^{2} g 0 + 3 g {4}^{2} g 7 + 3 g 5 g {7}^{2} + 3 g {6}^{2} g 4 + 3 g {9}^{2} g 2 + 6 g {2}^{2} g 9 + 3 g {6}^{2} g 3 + 3 g 9 g {6}^{2} + 3 g {9}^{2} g 7 - 5 g 2 g 8 g 6 - 11 g 2 g 0 g 9 - 5 g 2 g 4 g 0 - 11 g 9 g 1 g 8 + 6 g 8 g 7 g 6 - 5 g 9 g 8 g 5 + 6 g 9 g 0 g 7 + g 2 g 8 g 5 + 6 g 2 g 0 g 7 - 5 g 2 g 1 g 8 + 6 g 0 g 4 g 9 + 12 g 0 g 7 g 6 + 6 g 1 g 0 g 9 + 6 g 1 g 4 g 0 - 5 g 9 g 4 g 8 - 5 g 8 g 4 g 7 - 11 g 8 g 5 g 6 + 6 g 8 g 7 g 5 + 6 g 7 g 4 g 6 + 6 g 8 g 1 g 6 - 5 g 8 g 3 g 7 + 6 g 8 g 4 g 3 - 5 g 9 g 0 g 6 + 6 g 5 g 7 g 6 + 6 g 2 g 0 g 3 - 5 g 2 g 4 g 8 + 12 g 2 g 7 g 9 + 6 g 0 g 5 g 6 + 6 g 0 g 7 g 5 - 5 g 1 g 0 g 7 + 12 g 9 g 3 g 8 + 6 g 0 g 3 g 9 - 5 g 0 g 4 g 7 - 11 g 5 g 4 g 7 - 5 g 3 g 7 g 6 + 5 g 2 g 0 g 6 - 5 g 2 g 3 g 8 - 11 g 1 g 0 g 3 - 5 g 1 g 4 g 8 - 5 g 9 g 2 g 6 - 5 g 0 g 3 g 7 + 5 g 0 g 4 g 3 - 5 g 8 g 1 g 5 + g 8 g 4 g 6 + g 9 g 0 g 5 + 6 g 3 g 4 g 7 - 5 g 3 g 7 g 5 + 6 g 2 g 0 g 5 + 6 g 2 g 1 g 9 - 5 g 1 g 0 g 6 + 6 g 1 g 3 g 8 - 11 g 1 g 4 g 2 - 5 g 9 g 1 g 7 - 5 g 9 g 2 g 5 - 11 g 9 g 7 g 6 - 5 g 0 g 4 g 6 + 6 g 8 g 3 g 6 + 6 g 8 g 4 g 5 + 6 g 5 g 4 g 6 - 5 g 2 g 1 g 7 + 6 g 2 g 4 g 9 - 5 g 2 g 7 g 6 + 6 g 1 g 0 g 5 + 6 g 9 g 4 g 7 + 6 g 9 g 5 g 6 - 5 g 9 g 7 g 5 - 5 g 0 g 3 g 6 - 5 g 0 g 4 g 5 + 6 g 8 g 3 g 5 + 6 g 5 g 3 g 6 - 11 g 3 g 4 g 6 + 6 g 2 g 1 g 3 - 5 g 2 g 3 g 9 + 6 g 2 g 4 g 7 - 5 g 2 g 5 g 6 + 6 g 2 g 7 g 5 + 6 g 1 g 4 g 9 + 6 g 1 g 7 g 6 + 12 g 9 g 1 g 6 - 5 g 9 g 3 g 7 - 5 g 9 g 4 g 3 + 6 g 0 g 3 g 5 + 3 g {1}^{2} g 8 - 8 g {2}^{2} g 7 - 8 g {4}^{2} g 6 + 3 g {2}^{2} g 1 + 3 g 3 g {4}^{2} + 3 g 8 g {5}^{2} - 8 g 9 g {7}^{2} - 8 g {1}^{2} g 2 - 8 g {4}^{2} g 5 - 8 g {5}^{2} g 6 - 8 g 1 g {6}^{2} - 8 g {2}^{2} g 4 - 8 g 2 g {7}^{2} - 8 g {5}^{2} g 7 - 8 g 8 g {3}^{2} - 8 g {9}^{2} g 1 - 8 g 9 g {4}^{2} - 8 g 0 g {5}^{2} + 3 g {1}^{2} g 4 + 6 g {2}^{2} g 6 + 3 g 1 g {7}^{2} - 8 g {2}^{2} g 3 + 3 g 2 g {4}^{2} - 5 g {9}^{2} g 4 - 6 g 0 g {3}^{2} + 3 g {1}^{2} g 9 + 3 g {2}^{2} g 5 + 3 g {3}^{2} g 7 + 3 g 1 g {4}^{2} - 8 g {3}^{2} g 4 + 3 g {9}^{2} g 3 + 3 g {5}^{2} g 4 + 3 g 9 g {5}^{2} - 8 g {1}^{2} g 3 + 3 g {3}^{2} g 6 + 3 g 2 g {5}^{2} + 6 g {5}^{2} g 3 - 8 g {1}^{2} g 6 - 8 g {3}^{2} g 5 + 3 g 2 g {3}^{2} + 6 g 3 g 4 g 5 + 6 g 2 g 1 g 6 + 6 g 2 g 3 g 7 + 12 g 2 g 4 g 3 - 5 g 1 g 3 g 9 - 5 g 1 g 4 g 7 - 5 g 1 g 5 g 6 - 5 g 1 g 7 g 5 - 5 g 9 g 1 g 5 + 6 g 9 g 4 g 6 + 6 g 2 g 1 g 5 - 5 g 2 g 4 g 6 + g 1 g 3 g 7 + 6 g 1 g 4 g 3 - 5 g 9 g 3 g 6 + 6 g 9 g 4 g 5 + 6 g 2 g 3 g 6 + 6 g 2 g 4 g 5 + 6 g 1 g 4 g 6 - 5 g 9 g 3 g 5 - 11 g 2 g 3 g 5 + 6 g 1 g 3 g 6 + g 1 g 4 g 5 - g {8}^{2} - g {0}^{2} - g {9}^{2} - g {7}^{2} - g {4}^{2} - g {6}^{2} - g {2}^{2} - g {5}^{2} - g {1}^{2} - g {3}^{2} + g {6}^{3} + g {3}^{3} + g {5}^{3} + 2 g {1}^{3} + g {2}^{3} + g {4}^{3} + g {9}^{3} + g {7}^{3}$$

The power computing unit 32 executes the arithmetic expression of the above Expression (69) to calculate the cube g³ of the input element of the algebraic torus. As a result, according to the computing device 30 according to the third embodiment, the cube computation can be performed at a smaller cost than using a common arithmetic expression.

### Other Embodiments

While the first to third embodiments have been described above, the degree of an extension field is not limited to the second, third, and tenth degrees. In other words, the input unit may input an element of an algebraic torus selected from elements of an M-th (M is an integer not smaller than 2) degree extension field obtained by extending a finite field by an M-th order polynomial in the form of vector representation.

Furthermore, the n-th power is not limited to a square and a cube. In other words, the power computing unit may compute an n-th power (N is an integer not smaller than 2) of an element of an M-th degree extension field expressed in the form of vector representation. In this case, the power computing unit computes the N-th (N is an integer not smaller than 2) power of the input element of the algebraic torus, computing the N-th power being performed on the basis of an arithmetic expression for obtaining the N-th power of an element of an M-th degree extension field expressed in the form of vector representation, and the arithmetic expression being satisfied when the element of the M-th degree extension field satisfies the condition for an element of an algebraic torus. The arithmetic expression for obtaining the N-th power of an element of the M-th degree extension field can be derived by rearranging an arithmetic expression for obtaining the N-th power of an element of the M-th degree extension field expressed in the form of vector representation by an expression derived by substituting expressions representing an element of the M-th degree extension field and Frobenius conjugate elements into the expression representing the condition for an element of an algebraic torus.

Next, a hardware configuration of a computing device according to the first, second, and third embodiments will be described with reference to FIG. 4. FIG. 4 is an explanatory diagram illustrating a hardware configuration of a computing device according to the first, second, and third embodiment.

The computing device according to the first, second, and third embodiments includes a controller such as a central processing unit (CPU) 51, a storage unit such as a read only memory (ROM) 52 and a random access memory (RAM) 53, a communication interface (I/F) 54 for connecting to a network for communication, and a bus 61 that connects these components.

Computational programs to be executed by the computing device according to the embodiments are embedded on the ROM 52 or the like in advance and provided therefrom.

The computational programs to be executed by the computing device according to the embodiments may alternatively be recorded on a computer readable recording medium such as a compact disk read only memory (CD-ROM), a flexible disk (FD), a compact disk recordable (CD-R), and a digital versatile disk (DVD) in a form of a file that can be installed or executed, and provided as a computer program product.

Alternatively, the computational programs to be executed by the computing device according to the embodiments may be stored on a computer system connected to a network such as the Internet, and provided by being downloaded via the network. Still alternatively, the computational programs to be executed by the computing device according to the embodiments may be provided or distributed through a network such as the Internet.

The computational programs to be executed by the computing device according to the embodiments can cause a computer to function as the respective components (the input unit and the power computing unit) of the computing device described above. In the computer, the CPU 51 can read out the computational programs from a computer-readable storage medium onto a main storage unit and execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computing device comprising:
an input unit configured to input, in a form of vector representation, an element of an algebraic torus selected from elements of an M-th (M is an integer of 2 or greater) degree extension field obtained by extending a finite filed by an M-th order polynomial; and
a power computing unit configured to compute an N-th (N is an integer of 2 or greater) power of the input element of the algebraic torus,
computing the N-th power being performed on the basis of an arithmetic expression for computing the N-th power of an element of the M-th degree extension field expressed in the form of vector representation, and
the arithmetic expression being satisfied when the element of the M-th extension field satisfies a condition for an element of the algebraic torus.

2. The device according to claim 1, wherein
the input unit inputs, in the form of vector representation, an element of an algebraic torus selected from elements of a quadratic extension field obtained by extending a finite field by a quadratic polynomial, and
the power computing unit computes a square of the input element of algebraic torus,
computing the square being performed on the basis of an arithmetic expression for squaring an element of the quadratic extension field expressed in the form of vector representation, and
the arithmetic expression being satisfied when the element of the quadratic extension field satisfies a condition for an element of the algebraic torus.

3. The device according to claim 2, wherein
the quadratic extension field is i²−b where i represents a variable and b represents an element included in the finite field, and
an expression expressing the condition for an element of the algebraic torus is g^{q+1}=1 where an element of the quadratic extension field is represented by g and an order of the element of the finite field is represented by q.

4. The device according to claim 3, wherein the computing unit computes the following Expression (1):
g²=(2g₀²−1)+2g₀g₁i (1)
when a coefficient of a zero order term and a coefficient of a first order term of the input element of the algebraic torus are represented by g₀ and g₁, respectively.

5. The device according to claim 1, wherein
the input unit inputs, in the form of vector representation, an element of an algebraic torus selected from elements of a cubic extension field obtained by extending a finite field by a cubic polynomial, and
the power computing unit computes a cube of the input element of algebraic torus,
computing the cube being performed on the basis of an arithmetic expression for cubing an element of the cubic extension field expressed in the form of vector representation, and
the arithmetic expression being satisfied when the element of the cubic extension field satisfies a condition for an element of the algebraic torus.

6. The device according to claim 5, wherein
the cubic extension field is t³−s where t represents a variable and s represents a value included in the finite field, and
an expression expressing the condition for an element of the algebraic torus is g^{q̂2+q+1}=1 where an element of the cubic extension field is represented by g and an order of the element of the finite field is represented by q.

7. The device according to claim 6, wherein the computing unit computes the following Expression (2):
$${g}^{3} = ( 1 + 9 {sg}_{0} {g}_{1} {g}_{2} ) + 3 ( {g}_{0}^{2} {g}_{1} + {sg}_{2} {h}_{2} ) t + 3 ( {g}_{2} {g}_{0}^{2} + {g}_{1} {h}_{1} ) {t}^{2} \qquad ( 2 )$$
where
h₁=sg₂²+g₀g₁
h₂=g₁²+g₀g₂
when a coefficient of a zero order term, a coefficient of a first order term, and a coefficient of a second order term of the input element of the algebraic torus are represented by g₀, g₁, and g₂, respectively.

8. The device according to claim 1, wherein
the input unit inputs, in the form of vector representation, an element of an algebraic torus selected from elements of a tenth degree extension field obtained by extending a finite field by a tenth order polynomial, and
the power computing unit computes a cube of the input element of algebraic torus,
computing the cube being performed on the basis of an arithmetic expression for cubing an element of the tenth degree extension field expressed in the form of vector representation, and
the arithmetic expression being satisfied when the element of the tenth degree extension field satisfies a condition for an element of the algebraic torus.

9. The device according to claim 8, wherein
the tenth degree extension field is v¹⁰+v⁹+v⁸+v⁷+v⁶+v⁵+v⁴+v³+v²+v+1 where v represents a variable, and
an expression expressing the condition for an element of the algebraic torus is g^{q̂4-q̂3+q̂2-q+1}=1 where an element of the tenth degree extension field is represented by g and an order of the element of the finite field is represented by q.

10. A computing method comprising:
inputting by a computer, in a form of vector representation, an element of an algebraic torus selected from elements of an M-th (M is an integer of 2 or greater) degree extension field obtained by extending a finite filed by an M-th order polynomial; and
computing by a computer an N-th (N is an integer of 2 or greater) power of the input element of the algebraic torus,
computing the N-th power being performed on the basis of an arithmetic expression for computing the N-th power of an element of the M-th degree extension field expressed in the form of vector representation, and
the arithmetic expression being satisfied when the element of the M-th degree extension field satisfies a condition for an element of the algebraic torus.

11. A computer program product comprising a computer-readable medium containing a computer program that causes a computer to execute:
inputting, in a form of vector representation, an element of an algebraic torus selected from elements of an M-th (M is an integer of 2 or greater) degree extension field obtained by extending a finite filed by an M-th order polynomial; and
computing an N-th (N is an integer of 2 or greater) power of the input element of the algebraic torus,
computing the N-th power being performed on the basis of an arithmetic expression for computing the N-th power of an element of the M-th degree extension field expressed in the form of vector representation, and
the arithmetic expression being satisfied when the element of the M-th degree extension field satisfies a condition for an element of the algebraic torus is satisfied.
